(19) United States
(12) Patent Application Publication
(10) Pub. No.: US 2016/0062977 A1
(43) Pub. Date: Mar. 3, 2016

(54) Interactive and Real-Time Absentee Reporting System for Schools, Parents and Other Institutions

(71) Applicants: Sandra Wilkinson, Powell, OH (US); Sherrie Wilkinson, Powell, OH (US)

(72) Inventors: Sandra Wilkinson, Powell, OH (US); Sherrie Wilkinson, Powell, OH (US)

(21) Appl. No.: 14/835,484

(22) Filed: Aug. 25, 2015

Related U.S. Application Data
(60) Provisional application No. 62/043,382, filed on Aug. 28, 2014.

(51) Int. Cl. G06F 17/24; H04L 29/08; H04L 12/58; G06F 3/0484; G06F 3/0482

(52) U.S. Cl. CPC G06F 17/243; G06F 3/04842; G06F 3/0482; H04L 51/043; H04L 67/02; H04L 67/10

(57) ABSTRACT

A method and system are disclosed for interactive participation by parents with educational/school facilities and other governmental institutions wherein all are kept aware of the current location and the current absentee and other documented conditions (grades/tardiness/absentee record etc.) of a specific student.

### CROSS-REFERENCE TO RELATED APPLICATIONS

This application claims the benefit of United States Provisional patent application with Ser. No. 62/043,382 filed Aug. 28, 2014 by Sandra Wilkinson and Sherrie Wilkinson and entitled “Interactive and Real-Time Absentee Reporting System for Schools, Parents and Other Institutions”.

### FIELD OF INVENTION

This invention relates to an Interactive and Real-Time Absentee Reporting System for Schools, Parents and Other Institutions. More particularly, this invention relates to systems and methods for tracking the location of individuals, such as students entering or leaving a classroom/school and for managing critical student information. The present invention also relates to methods of reporting student behavior, and in particular a method of reporting student relevant data including behavior (and grades) to parents and interested institutions over a computer network. This invention relates to an attendance monitoring system. More particularly, the invention is directed to a system that provides to a school system, parents or interested institutions an instant visual representation of a student's daily attendance (including that for the present day) and attendance history (which is an indicator of potential concerns). The present embodiments further relate to an immediate response information or emergency system for guardians, employees, and students associated with an institution, such as a school or a school system relating to student daily attendance which can relate to tracking attendance of a child in case of an emergency situation or knowing where the child is while in an institution or school system. This invention relates to data logging systems, and in particular, to systems for logging or registering items of data related to persons. It is, although not exclusively, adapted for use as a classroom roll-taking system, for recording the presence or absence of pupils or students, their test results and other such data.

### FEDERALLY SPONSORED RESEARCH

None.

### SEQUENCE LISTING OR PROGRAM

None.

### BACKGROUND

### Field of Invention and Prior Art

As far as known, there are no Interactive and Real-Time Absentee System for Schools, Parents and Other Institutions or the like. It is believed that this process/system is unique in its manner and technologies.

### GENERAL BACKGROUND

For many educational and other institutions, tracking attendance can be a time-consuming and tedious chore. Most educational facilities and systems perform the task of collecting and maintaining student information by using time worn manual accounting techniques. Typically, a teacher takes attendance manually, by asking each student to state “here” when his or her name is called, or by scanning the classroom to determine which students are present. The teacher then writes the information down, and it is transmitted to the school administration, often by hand (or a computerized system). The teacher's entries are then manually transferred to a more permanent record for storage and/or subsequent forwarding to a school district office. The mere fact that the entire accounting process is manually performed by a number of different people presents the strong likelihood that errors are created, accumulated, and then compounded.

The time spent taking attendance is typically multiplied by the fact that students tend to rotate from classroom to classroom as they change subjects; as a result, attendance must be taken each class. Some form of centralized attendance information processing must therefore be employed in which data from each classroom and teacher is combined to result in an attendance profile with respect to each individual student. Typically, if this task is performed, it is done on paper in a very slow and clerical manner. (Most schools are using some form of software attendance). Importantly, if a student enters the class late, after attendance has been taken, the teacher must take note of that fact, and interrupt teaching to update his or her attendance records. This traditional method of tracking attendance suffers from a number of drawbacks. The process is tedious, time-consuming, and subject to human error. Like all paper-based recordkeeping systems, the system is vulnerable to lost or misfiled data. The consequences of poor attendance recordkeeping can be significant for schools, administrators, and school districts. Throughout the country, average daily attendance (ADA) is a critical statistic that is used to determine school funding. Since school funding is based on ADA figures, schools lose money every time a student is absent. And when poor or inconsistent attendance tracking wrongly indicates that a present student is absent, the school needlessly loses funding.

Student information is useful to present-day educational facilities for a number of reasons other than simply satisfying the requirement for monitoring students' progress. For example, student body attendance is often the factor on which state and/or federal financial assistance is based. Recognizing that errors are common, governmental agencies have instituted auditing procedures to ensure accuracy. An automated system would not only ensure accuracy but would also eliminate the need for such audit procedures and hence produce a governmental savings. As a further example, school administrators are frequently faced with having to solve problems attendant to student unrest and campus disturbances. It has been found that such disturbances sometimes can be predicted, and possibly pre-empted and avoided, by monitoring the attendance records and campus whereabouts, i.e., is a student in the proper classroom, of known and/or suspected instigators. Quite obviously, manual accounting techniques are totally unsuitable for this purpose when such checking must be performed on a class period basis or at other similarly short and regular time intervals through a day. An automated system (possibly/probably already in place) would make student information continually available at a minute's notice. Additionally, traditional attendance tracking methods make it difficult to prepare the attendance reports required by governmental agencies. Various agencies require ADA and other data to be reported in particular formats, but the traditional methods of tracking attendance do not provide an easy way to prepare these reports.

The education system is currently struggling to provide a uniformly high quality of education to students. A significant problem is the lack of an effective means of involving parents in the daily educational experience of their children. Parents often both have full-time jobs, or are single parents, such that it is difficult to continuously interact with teachers and school administrators. As a result, student relevant data including the negative and positive behavior of the students in class, the completion of homework, attendance, and general informational and other data may not become known to the parents in a timely manner. Consequently, parents are often not a position to help resolve their child's behavioral problems in a timely manner. What is needed therefore is a method that enables teachers and administrators to more easily report student relevant data to parents. This data and communication will be protected from errant disclosure by electronic signatures and/or pin codes. Similarly, teachers are often burdened with ever increasing student class loads, administrative duties, and paperwork. Consequently, teachers typically rarely contact parents to discuss problems which are developing, often due to the time and effort required to reach the parents. This leads to conflicts during progress report time when parents ask, “Why didn't I know about this sooner?” What is needed is method that enables teachers and administrators to inform parents more often and in a timely and meaningful way. An electronic process is a good solution.

Most schools maintain attendance records to track whether students attend school. It is known in the art to process these attendance records to generate automated alerts that are broadcast to the guardians for absent students. However, to the inventors' knowledge, such systems often result in the school district's telephone lines being inundated with responsive telephone calls from guardians shortly after the alerts are broadcast. Typically, such inundation occurs shortly after the broadcasts regarding student absences are sent out and continues for an hour or more thereafter. During this time, school personnel are bombarded with telephone calls from guardians to explain why their respective children were absent, which pulls those personnel away from their other work tasks. Given the consistent and intermittent patterns of these calls from guardians, school personnel are rendered highly unproductive during this time. Furthermore, given some people's talkative natures, it is not uncommon for these telephone calls from guardians regarding their child's absence to branch out into other topics which further hinders the productivity of the school personnel.

With the improved capabilities of computer software and networks with respect to handling information storage and retrieval, various types of systems have arisen for automating, to various degrees, the management of information. Additionally, with the advent of various new types of communications, such as email and cell phones, the ability to effectively communicate information to interested individuals has likewise increased. In an effort to provide a solution to these problems, the inventors disclose methods and systems for intelligently notifying first parties. This solution is via email, cell phone applications, and automated telephone calls regarding an absence by second parties at an event with minimal burden on a third party who manages attendance issues for the event. By electronic signatures and/or pin codes, confidential data is protected. The system and method invented and now shown here is believed to meet or exceed all concerns with HIPAA [the federal Health Insurance Portability and Accountability Act that is to protect the confidentiality and security of healthcare information] and/or FERPA [Family Educational Rights and Privacy Act Federal law that protects the privacy of student education records] requirements. Preferably, the event is a school session, the second parties are students who are supposed to attend the school session, the first parties are parents/guardians for the students, and the third party is a school employee or other institutional agencies who handles attendance issues.

To date, little has been done to implement this type of automation in a way that is adapted to accommodate the information that must be managed in typical school systems. A standard school district may have thousands of students, ranging from kindergarten (and in some cases, even, publicly funded pre-school) through twelfth grade. These students will typically be dispersed throughout different schools that are based on school level, such as elementary, middle, junior high, and high schools, and in larger towns or cities, multiple numbers of such schools may exist that further divide up a multitude of students based on geographic location. For example, in a medical emergency, a school nurse or a soccer coach may suddenly need to have access to a student's medical information in order to appropriately diagnosis or treat the student. Similarly, they may need to access the contact information for the student's parent or guardian in such an emergency. Generally, such information is kept in a “hard” file, such as a file folder, or more recently, in a basic computer database. Further, in certain situations, a school official may need to contact the parents of certain groups of individuals, such as to let to the parents of students on a particular team know that a practice has been cancelled, or to notify all parents of the students in a particular school that there will be an early dismissal due to a loss of heat, or to inform all the parents in a school district of a snow closing. Generally, such communication is carried out by manually telephoning the parents of the students in order to reach whoever can be reached, or by some form of passive communication of the information, such as by posting the information on a website or reporting it to radio and/or telephone (vision) stations, in which case it is incumbent upon the parents to be aware that the information is being communicated in the first place.

### Problem Solved

Therefore, there is a need for an automated attendance monitoring system that not only counts and identifies tags or cards as they enter or leave a classroom, but that also has robust means for ensuring the integrity of the attendance data, and that has the ability to prepare customized attendance reports for use by parents, education personnel, governmental agencies and others.

As such, it would be desirable to have a convenient system that provides a daily awareness of attendance status and of the reliability of the staff that is available. (Parents have the ability to mark their own child absent, late or early release straight to the school record, via computer, cell phone or landline) These and other features and advantages of the present invention will be apparent to those having ordinary skill in the art upon a review of the disclosure herein.

What is desired, therefore, is a system for managing critical student information that effectively manages information for various different groups of students. What is further desired is a system for managing critical student information that regulates the ability of different users to access and send information for different student groups. What is also desired is a system that efficiently communicates, transfers, and tracks the student information.

Institutions, such as schools or school systems, need a system to send and receive information using a variety of messaging formats, systems, and message receiving devices. Often the messages will vary in their level of importance. This could affect the delivery methods and/or the nature and timing of any needed response to the message. For example, the arrival of an e-mail message from a particular sender might cause the recipient to fax a report in response. In some group messaging contexts, the post-message processing, organizing, and reporting of multiple message responses can be important in further decision making by the message originator.

What is needed is a method and supporting apparatus for taking school attendance which may be adapted for use in schools with a large number of class rooms, laboratories and other area which combines distributed and centralized processing of data to allow teachers to transmit information to, and receive information from a central office computer and available to other education personnel, parents, guardians, governmental agencies, and information contained on secured cloud servers.

### PRIOR ART

A U.S. Pat. No. 8,543,086 entitled “System for schools managing SMS credits using mobile reverse charge technology” was issued to Fortunatow in 2013. It demonstrated a method of billing or charging a receiver for a mobile communication being message, that allows the receiver to receive messages as part of a service, the receiver being billed directly by the telecommunications carrier who then in turn aggregates a revenue share based on messages sent to receivers, who then in turn pay a percentage of the revenue share to the premium SMS aggregator. The receiver can be of a selected status, which is set to a pre-selected schedule and can receive messages without charge or with a charge. This enables the payment system to be simple and efficient. This invention fails to show the steps and simple/more efficient process of the Wilkinson technology. Another U.S. Pat. No. 8,353,705 entitled “Attendance tracking system” was issued to Dobson et al. in 2013 which taught an automated attendance monitoring system is disclosed. The system includes (i) identification tags, with wireless communication capabilities, for each potential attendee, (ii) scanners for detecting the attendees' tags as they enter a given room, (iii) at least one server in communication with the scanners, (iv) handheld computing devices for use by attendance trackers, such as teachers, to verify a provisional attendance report generated by the scanners and server, and (v) software running on the server for receiving and managing the attendance data received from the scanners, and for generating attendance reports. Although particularly well-suited for tracking attendance in schools, the present invention can also be used in a variety of other settings where there is a need to track the whereabouts of a number of individuals. This invention fails to show the verification steps and more efficient/economically feasible process of the Wilkinson technology. Wilkinson provide specific security and accountability of who's custody the child is in entrusted.

A United States patent application was published as No. US2012/02968 interactive comments capability entitled “System and method for performing substitute fulfillment” by Thompson et al. in 2012. This showed a system and method for automating the performance of substitute fulfillment. The system includes a server which receives absentee information representing an absent worker via a telephone communication link or an Internet communication link. In response to receiving the absentee information, the system generates a list of potential substitute workers. The system then contacts potential substitute workers until one is found or until the list is exhausted. The system can also post a list of positions that are available on a website allowing potential substitute workers to search for a position. This invention fails to show the steps and simple/more efficient process of the Wilkinson technology. Much more laborious interface with office and teaching professionals is required by Thompson as compared to the Wilkinson invention. A United States patent application was published as U.S. Pat. No. 8,180,274 entitled “System for managing and messaging critical student information” was issued to Bender in 2012 that provided a system for managing critical student information is disclosed generally comprising storing information associated with individual students, such as important medical information or contact information for the student's parent or guardian, and providing different authorized users, such as school administrators, teachers, or coaches, permission to access the information and/or send messages for particular students. The stored information for each student is associated with one or more group identifiers, which identify particular groups of which the student is a member, such as a school or team, and each authorized user is likewise associated with one or more group identifiers, which identify the particular groups for which the user has access and can send messages. The Bender idea merely addresses an internet connective system and fails to address the wide provisions shown by Wilkinson, et al.

A U.S. Pat. No. 7,684,548 entitled “Notification and response system with attendance tracking features” was issued to Rodkey et al. in 2010 that taught and demonstrated a notification and response system utilizes an administrator interface to transmit an attendance messages from an administrator to a contact devices for guardians, employees, and students associated with an institution. The system comprises a dynamic information database that includes guardian, employee and student contact data, priority information, and response data. The administrator initiates distribution of the attendance message based upon grouping information, priority information, and the priority order. The message is transmitted through at least two industry standard protocol simultaneously to groups of guardian, employee, and student contact devices based upon priority information. Once the attendance message is received by the guardian, employee, or student contact devices, the guardian, employee, and student contact devices transmit a response through the industry standard protocol back to the dynamic information database. Rodkey is a notification system and lacks most of the interactive features offered by Wilkinson, et al. A United States patent application was published as No. US2007/0292835 entitled “Method for reporting student relevant data” was initiated by Hartman et al. in 2007. This showed a method for reporting student relevant data to parents that provides secure access by a validated user over a computer network to forms that enable the user to associate student relevant data categories with a particular student. The computer network enables selective display of the forms on a user's terminal. The method enables a user, e.g., teacher or administrator, to select a student and to associate student relevant data categories therewith. The method creates a message for each selected student corresponding to the associated student relevant data categories. The message is transmitted to parents; preferably in their language using prerecorded digital messages. Student relevant data comprises informational and behavioral data. The method preferably enables the user to select a set of students in one step and to concurrently associate student relevant data categories therewith. Messages sent by telephone to a parent are each preferably sent with different caller IDs. Hartman provides communication but lacks verification and historical data taught by Wilkinson, et al.

A United States patent application was published as No. US 2003/0167193 entitled “Attendance monitoring system” was applied for by Jones et al. in 2003. It taught an invention that relates to an attendance monitoring system. More particularly, the invention is directed to a system that provides to an employer an instant visual representation of an employee's daily attendance (including that for the present day), attendance history (which is an indicator of reliability), available paid time off, current vacation schedule, assignment status, training status, and the like. Jones et al. is primarily a monitoring system and lacks the interactive features and feedback to parents/guardians of Wilkinson. A U.S. Pat. No. 6,173,153 entitled “Method and apparatus for taking school attendance” was issued to Bittman in 2001 which demonstrates an apparatus for taking school attendance includes a central office computer 101 interfaced with a plurality of attendance telephones 102. Typically, the interface is based on telephone lines or similar hard-wired network. Each AT device may therefore communicate with the central office computer or another AT device by data transmitted through the central office computer. A telephone interface 104 allows the central office computer to outside computers 105, including particularly the school district's central computer and database. The structure and organization of the software associated with the apparatus includes functionality related to the taking, recording and transmitting of school attendance and other purposes. Bittman is an attendance system lacking the interactive feedback of Wilkinson, et al.

Another U.S. Pat. No. 5,956,696 entitled “Attendance registration system by radio link” issued to Guryel in 1999. This shows a method of electronically registering student attendance data includes storing a plurality of student names in a central collection station. The stored student names are downloaded and stored to at least one portable data collection device. The portable data collection device is used to access the set of student names stored therein and one select student name from the set of student names is displayed on a visual display of the portable data collection device. The portable collection device prompts an operator thereof to input attendance data for the select displayed student name into the portable data collection device. The operator input attendance data includes one of a first input indicating that the student having the select displayed name is present, a second input indicating that the student having the select displayed name is absent, and a third input indicating that the student having the select displayed name is tardy. The input attendance data for each select student name is stored in the portable collection device and the foregoing is repeated for each student name in the downloaded set of student names. The input student attendance data is then uploaded from the portable data collection device to the central data collection station and stored in said central data collection station. A student attendance report is generated using the attendance data stored in the central data collection station. Guryel again is an attendance system lacking the interactive feedback of Wilkinson, et al. Finally, as prior art, a U.S. Pat. No. 3,740,725 entitled “Automated attendance accounting system” was issued to Fletcher et al. in 1973. Here is shown and demonstrated an automated accounting system useful for applying data to a computer from any or all of a multiplicity of data terminals is disclosed. The system essentially includes a preselected number of data terminals which are each adapted to convert data words of decimal form to another form, i.e., binary, usable with the computer. Each data terminal may take the form of a keyboard unit having a number of depressible buttons or switches corresponding to selected data digits and/or function digits. A bank of data buffers, one of which is associated with each data terminal, is provided as a temporary storage. Data from the terminals is applied to the data buffers on a digit by digit basis for transfer via a multiplexer to the computer. A priority interrupt generator is employed to provide the computer with a signal indicating that stored data is available and being held in at least one of the data buffers for transfer to the computer. Upon receipt of such signals, the transfer of data is initiated by the computer controlling the multiplexer to scan the bank of buffers, by groups, in accordance with a programmed sequence. Available data is transferred from a buffer in which it is stored, when the buffer is scanned. The data may be first confirmed for accuracy. Each data buffer is individually reset by the computer subsequent to the transfer of data stored therein. A visual indication is provided at the data terminal keyboard, from which the data originated, after each successful transfer of a complete data word. Fletcher shows an antiquated system that fails to anticipate the modern telephone/internet/cellphone and application system shown by the Wilkinson system and process.

### SUMMARY OF THE INVENTION

This invention is an Interactive and Real-Time Absentee System for Schools, Parents and Other Institutions. The preferred embodiment of the Interactive and Real-Time Absentee System for Schools, Parents and Other Institutions is comprised of: (a) an existing absentee reporting system or new reporting system; (b) a portal means for communicating and exchanging information like a call-in website by email and/or cellphone application and/or telephone; (c) a log-in process to choose/and-or create a file for a specific child; (d) a review file of recent absentees and/or tardiness; (e) a manner to enter and/or edit a reason code for the absentee or tardiness; (f) a means for securely signing (electronic signature or pin codes or the like) for acknowledging absenteeism and other school forms; and (g) an interactive comments capability (like email comments; text comments through a smartphone application; an email a sound recording; email a video response; attach recorded comments through a smartphone application; and attach videoed comments through a smartphone application) wherein the Interactive and Real-Time Absentee System for Schools, Parents and Other Institutions may be accessed on a real time basis for interaction between school systems (teachers, secretary and administrators) with the parent, guardian and governmental institutions. An alternative embodiment is the system described above and further comprised of after school and curricular activities wherein sponsors or coaches can interact and advise parents/guardians, etc. of the location and presence of the student at such extracurricular activities.

### Objects and Advantages

There are several objects and advantages of the Interactive and Real-Time Absentee System for Schools, Parents and Other Institutions. There are currently no known interactive systems or processes for absentee tracking and reporting that are effective at providing the objects of this invention.

The advantages and benefits of the Interactive and Real-Time Absentee System for Schools, Parents and Other Institutions are:

| Item | Description |
|---|---|
| 1 | Decrease liability for the school |
| 2 | Saves paper - students will no longer have to |
| | physically bring in the note(documentation - |
| | Dr.'s note, funeral, court, etc . . . ) to the |
| | school nor risk losing the documentation |
| 3 | Save time for secretaries, teachers, parents, |
| | students and administration |
| | A. Parents won't have to call or write |
| | notes |
| | B. Students won't have to go to office |
| | if parents participate and wait in |
| | line at the attendance office |
| | C. Secretaries won't have to wait on as |
| | many individual students |
| | D. Administrators can look at compounded |
| | records * hopefully, based on parent |
| | participation, attendance records |
| | will be more accurate. |
| 4 | Better Security |
| | A. Direct communication Parent <-> School and |
| | vice versa. |
| | B. Electronic signatures and/or pins to meet |
| | or exceed HIPPA and FERPA requirements. |
| | C. More accountability about student's |
| | whereabouts and who is picking them up. |
| | D. More accountability for older students to |
| | be where they are supposed to be. |
| | E. Better timely notification to parents |
| 5 | Better documentation: more efficient and |
| | accurate. |
| 6 | The potential to assist non-school community |
| | services |
| 7 | Children are better protected |
| 8 | Parents gain more efficiency, freedom and |
| | empowerment over children's absence |
| | accountability. |
| 9 | Saves learning time - Kids don't have to wait |
| | in line to check in with attendance or get |
| | pass slips. |
| 10 | Parents are happier/staff happier promoting |
| | better working conditions. |
| 11 | Allows parents to feel more secure |
| 12 | Provides more convenience for the people (all |
| | parties) to communicate in a less social |
| | setting which according to statistics, will |
| | increase the participation. (They |
| | parents/guardians can email or upload, etc. |
| | without needing to talk to anyone). |

Finally, other advantages and additional features of the present Interactive and Real-Time Absentee System for Schools, Parents and Other Institutions will be more apparent from the accompanying drawings and from the full description of the device. For one skilled in the art of absentee tracking and reporting and in the art of interactive communications, it is readily understood that the features shown in the examples with this product are readily adapted to other types of tracking and reporting systems for various institutions—education, government, institutional and the like.

### DESCRIPTION OF THE DRAWINGS

### Figures

The accompanying drawings, which are incorporated in and constitute a part of this specification, illustrate an embodiment of the Interactive and Real-Time Absentee System for Schools, Parents and Other Institutions that is preferred. The drawings together with the summary description given above and a detailed description given below serve to explain the principles of the Interactive and Real-Time Absentee System for Schools, Parents and Other Institutions. It is understood, however, that the Interactive and Real-Time Absentee System for Schools, Parents and Other Institutions is not limited to only the precise arrangements and instrumentalities shown.

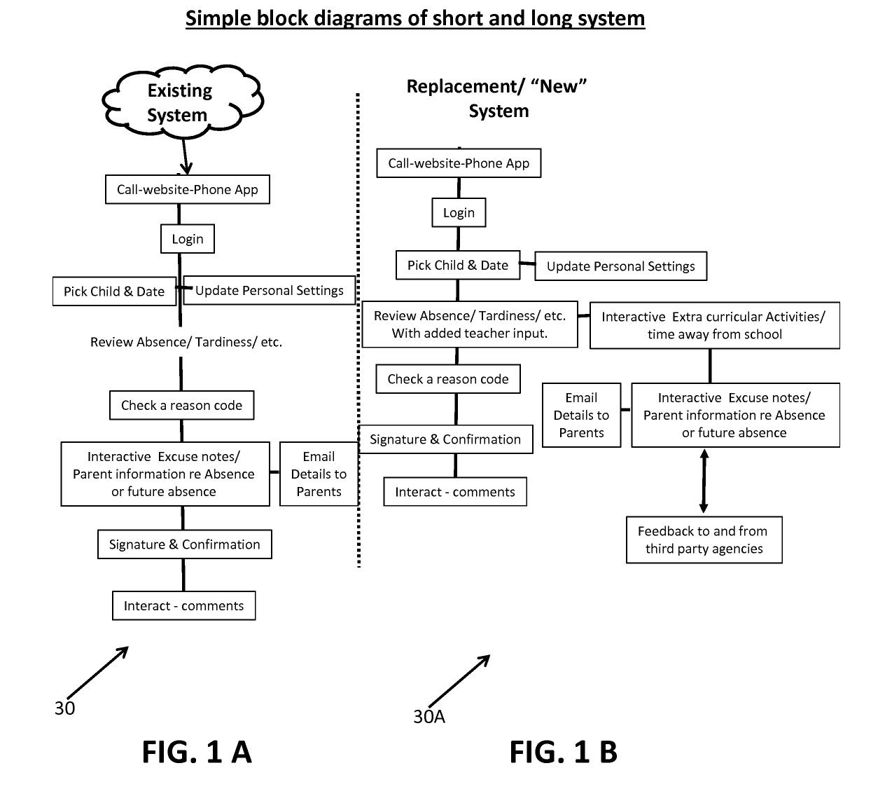

FIGS. 1 A and 1 B are sketches of the Interactive and Real-Time Absentee System for Schools, Parents and Other Institutions and Simple block diagrams of short and long systems.

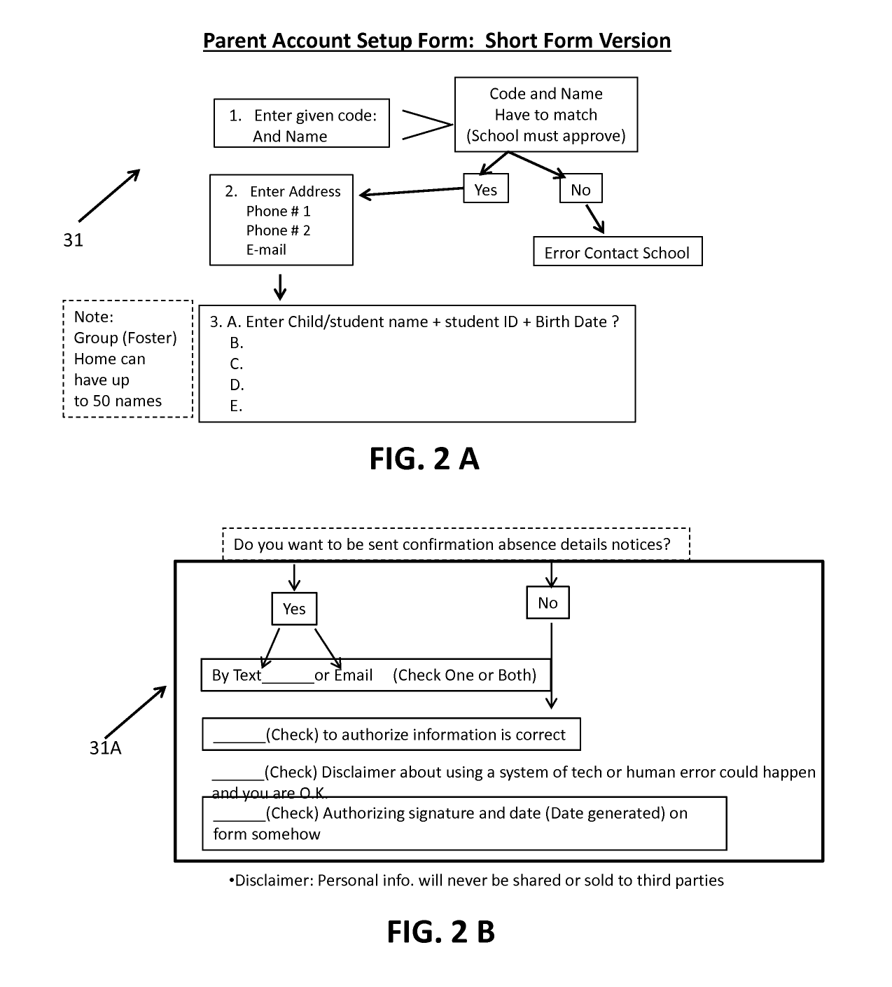

FIGS. 2 A and 2 B are sketches of the Parent Account Setup Form: Short Form Version as noted.

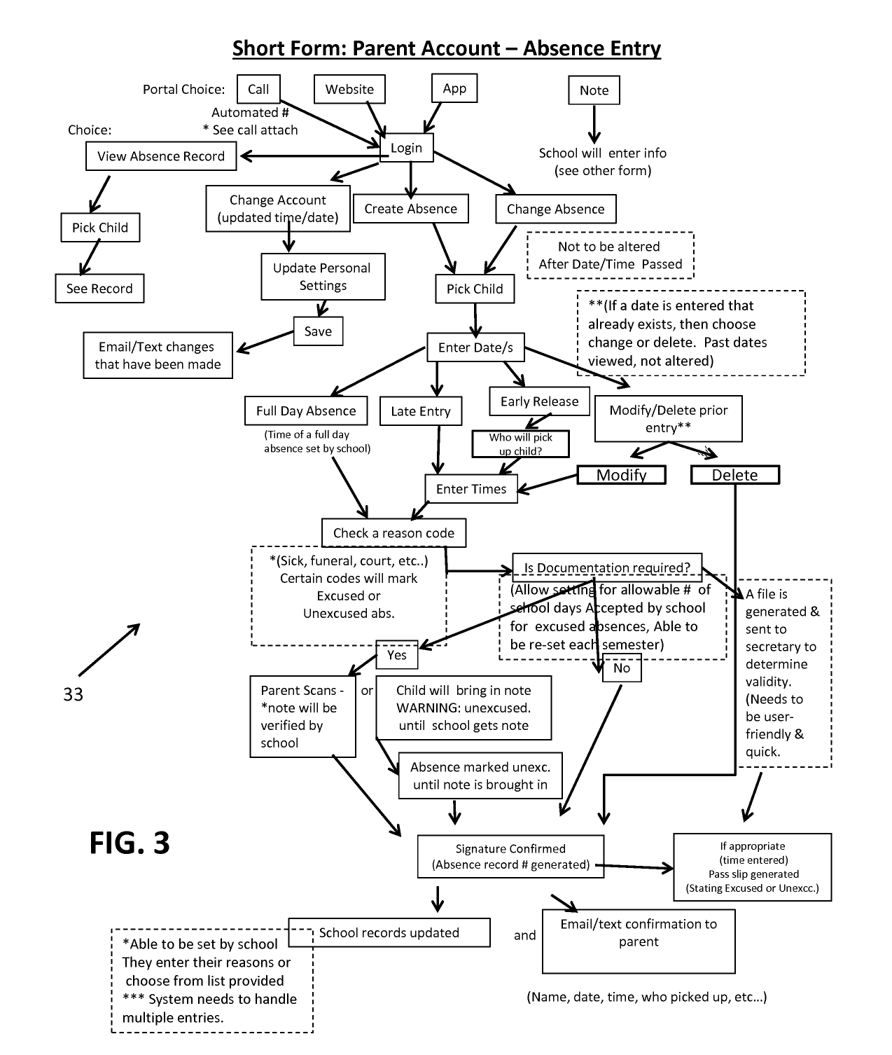

FIG. 3 is a flowchart of the Short Form: Parent Account—Absence Entry.

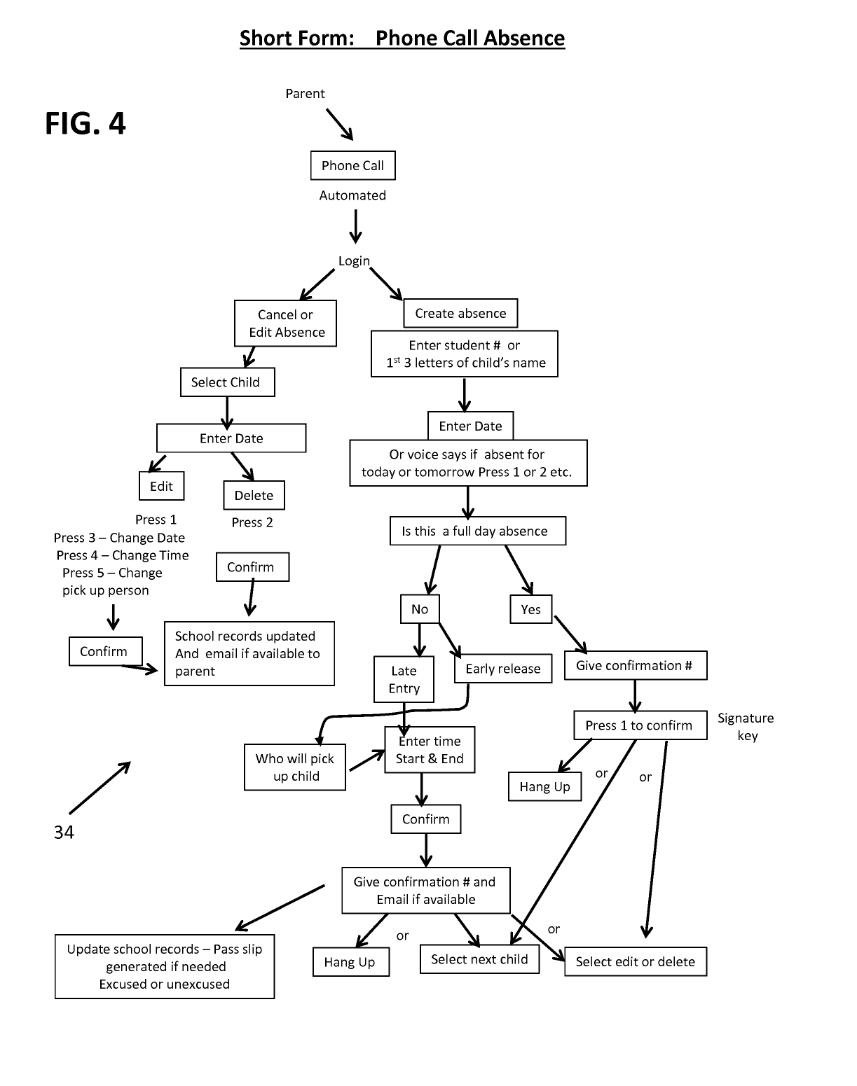

FIG. 4 is a flowchart of Short Form: Phone Call Absence.

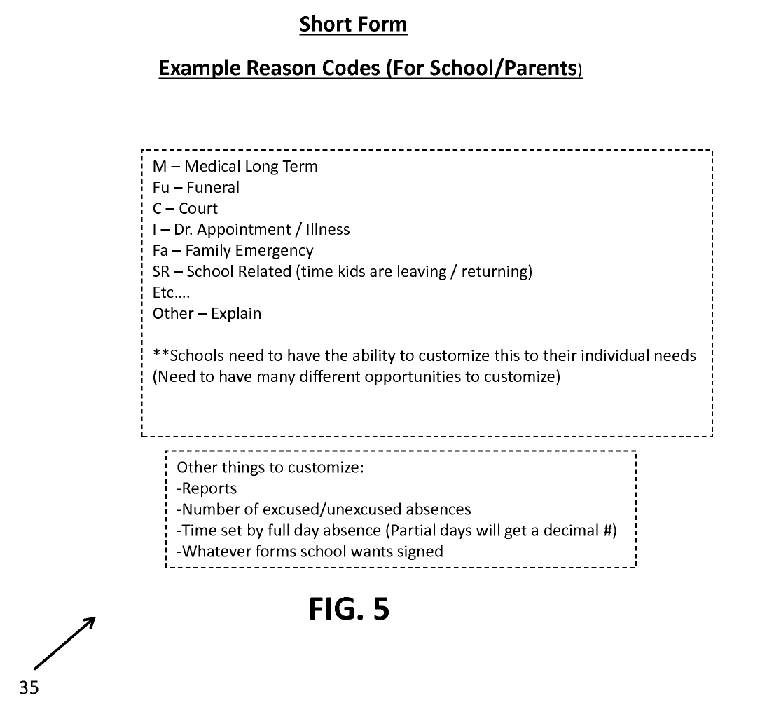

FIG. 5 is an Example Reason Codes (For School/Parents) for a Short Form.

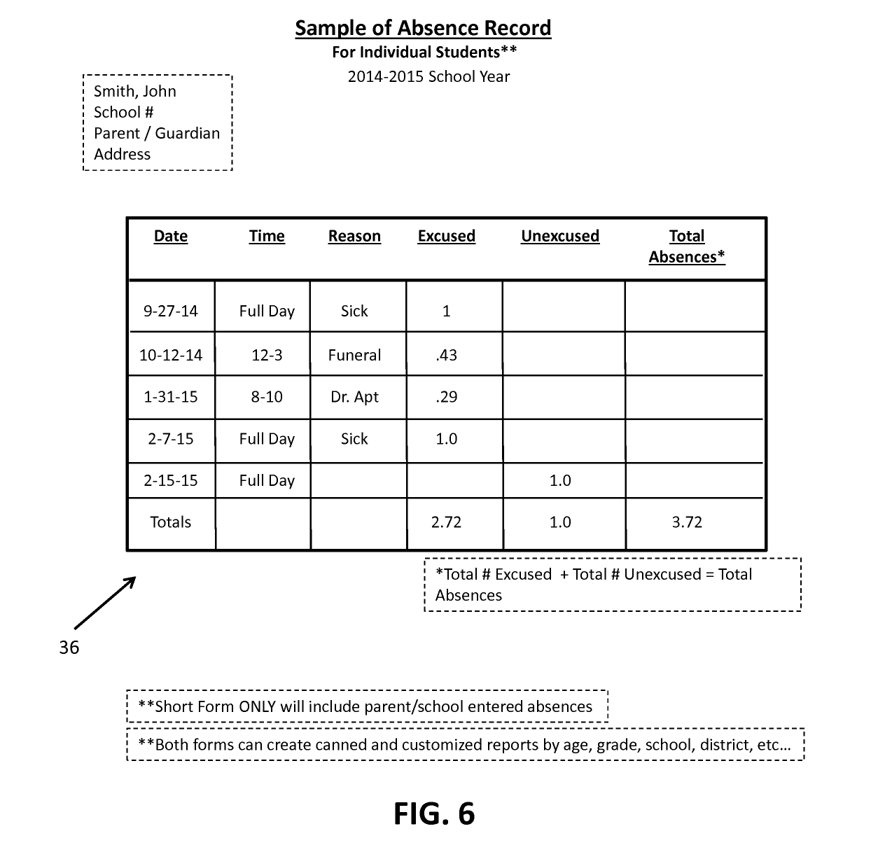

FIG. 6 is a Sample of Absence Record for a Short Form.

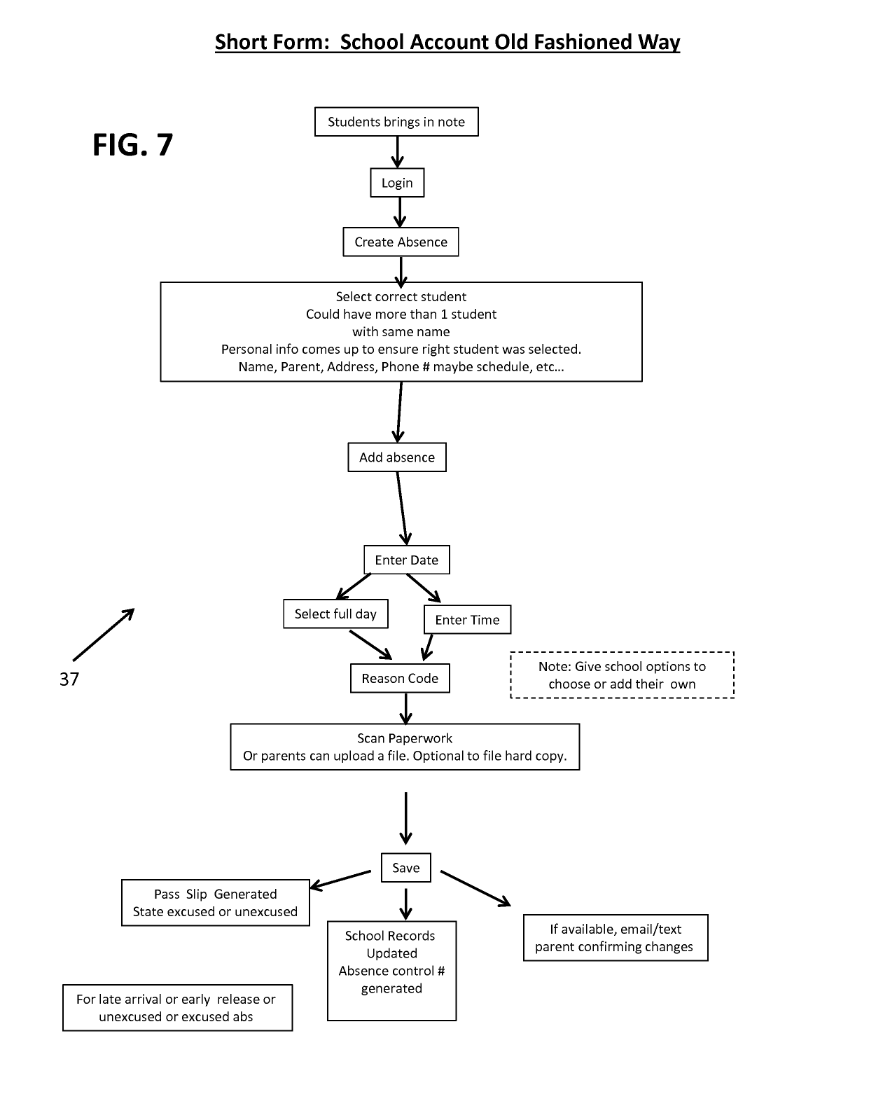

FIG. 7 is a Short Form: School Account by the Old Fashioned Way.

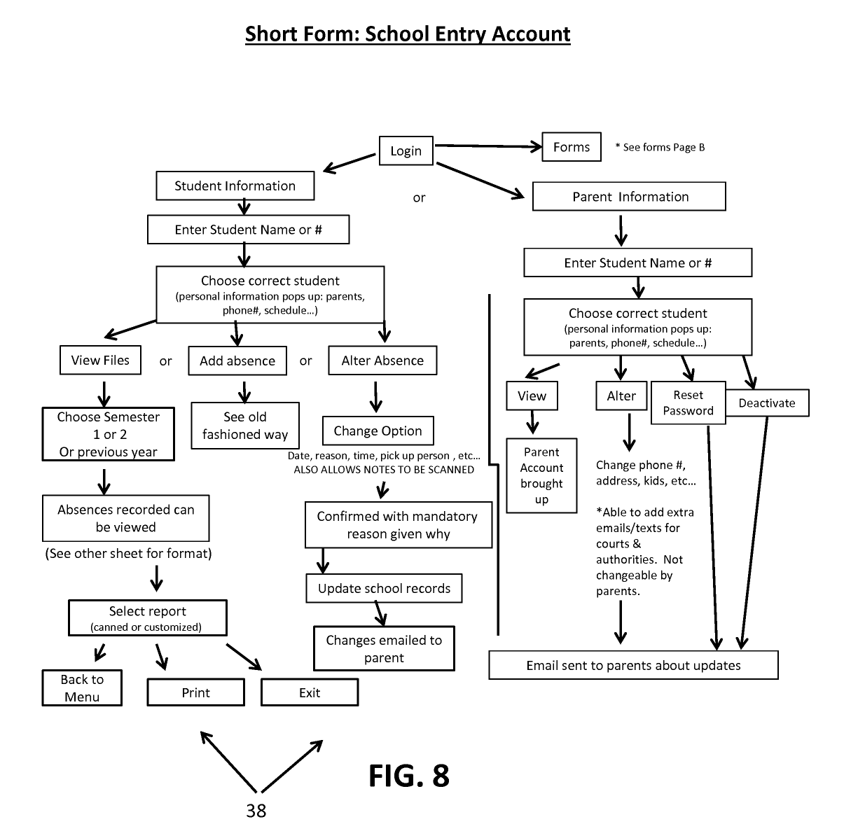

FIG. 8 is a Short Form: School Entry Account.

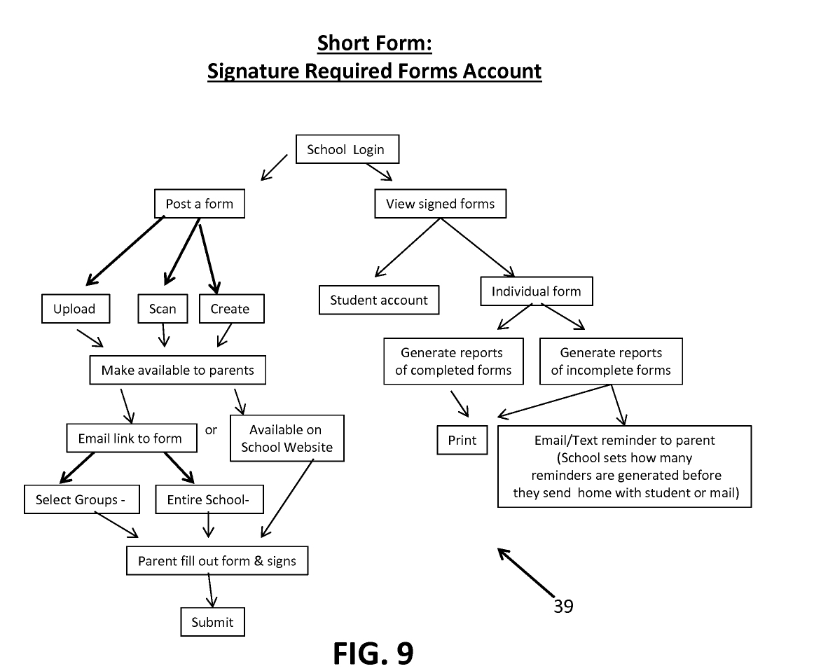

FIG. 9 is a Short Form Signature Required Forms Account.

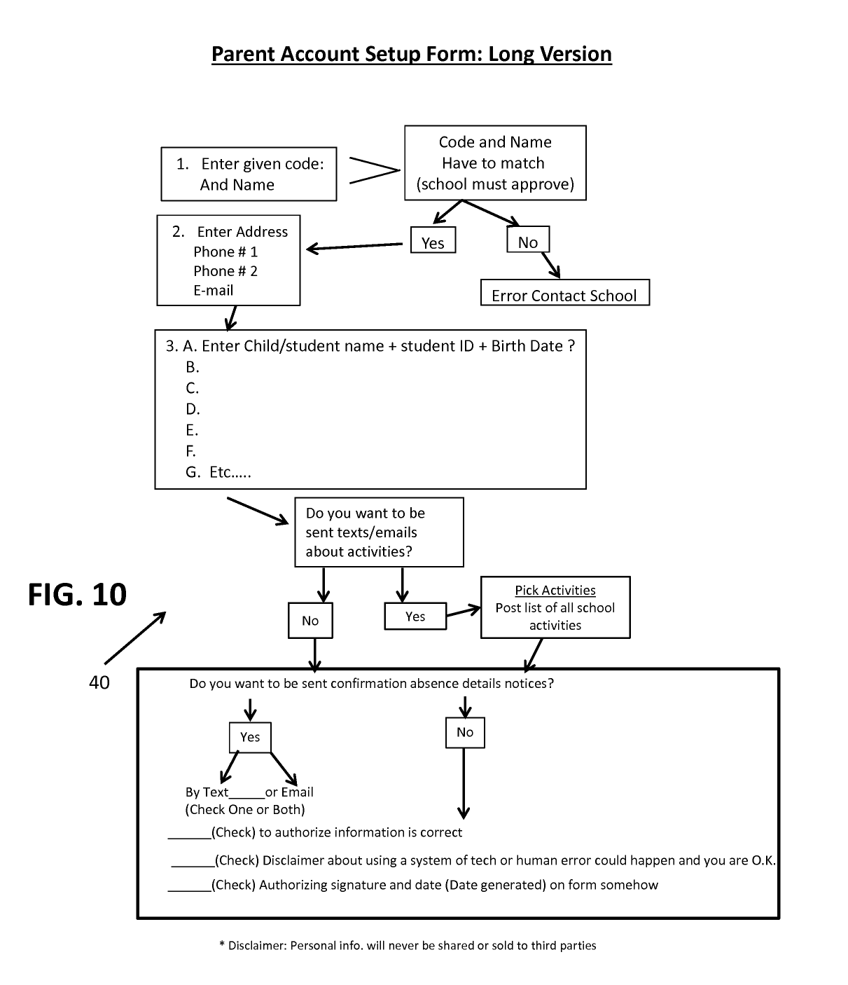

FIG. 10 is a Parent Account Setup Form: Long Form Version.

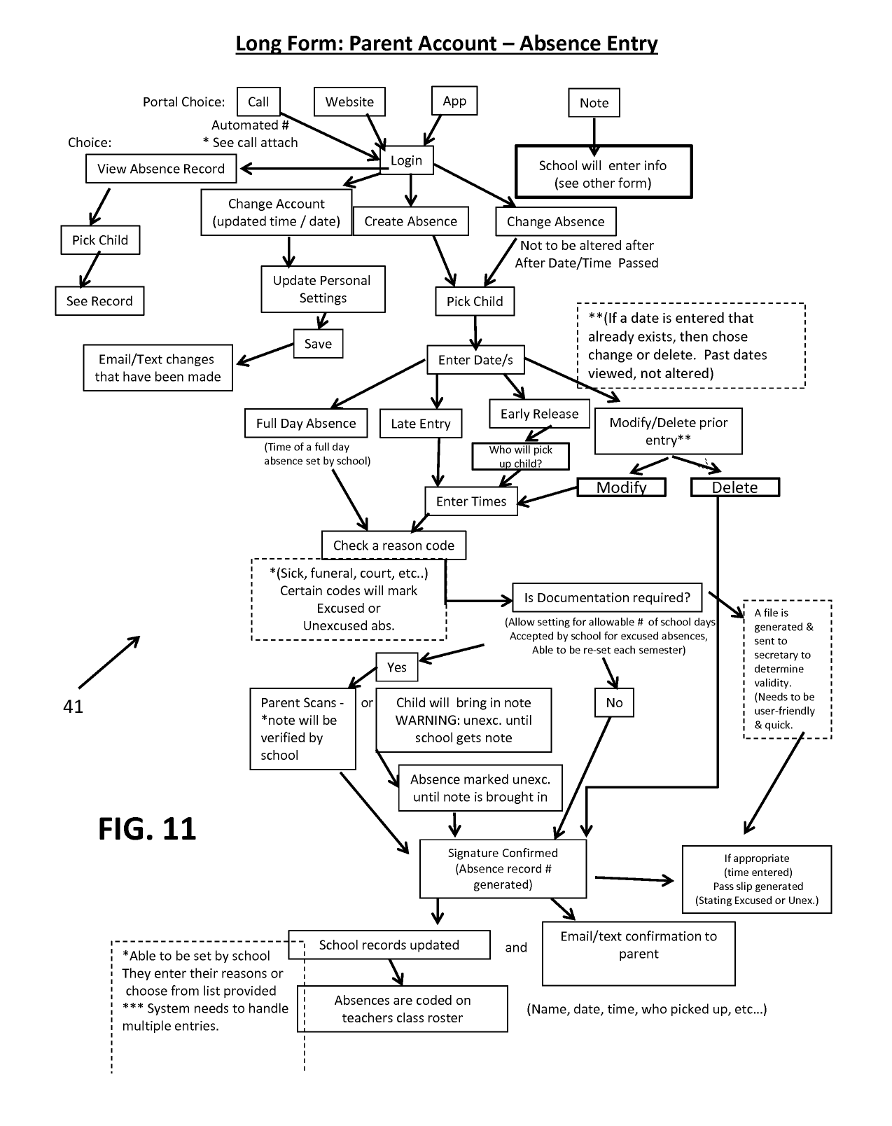

FIG. 11 is a Long Form: Parent Account—Absence Entry.

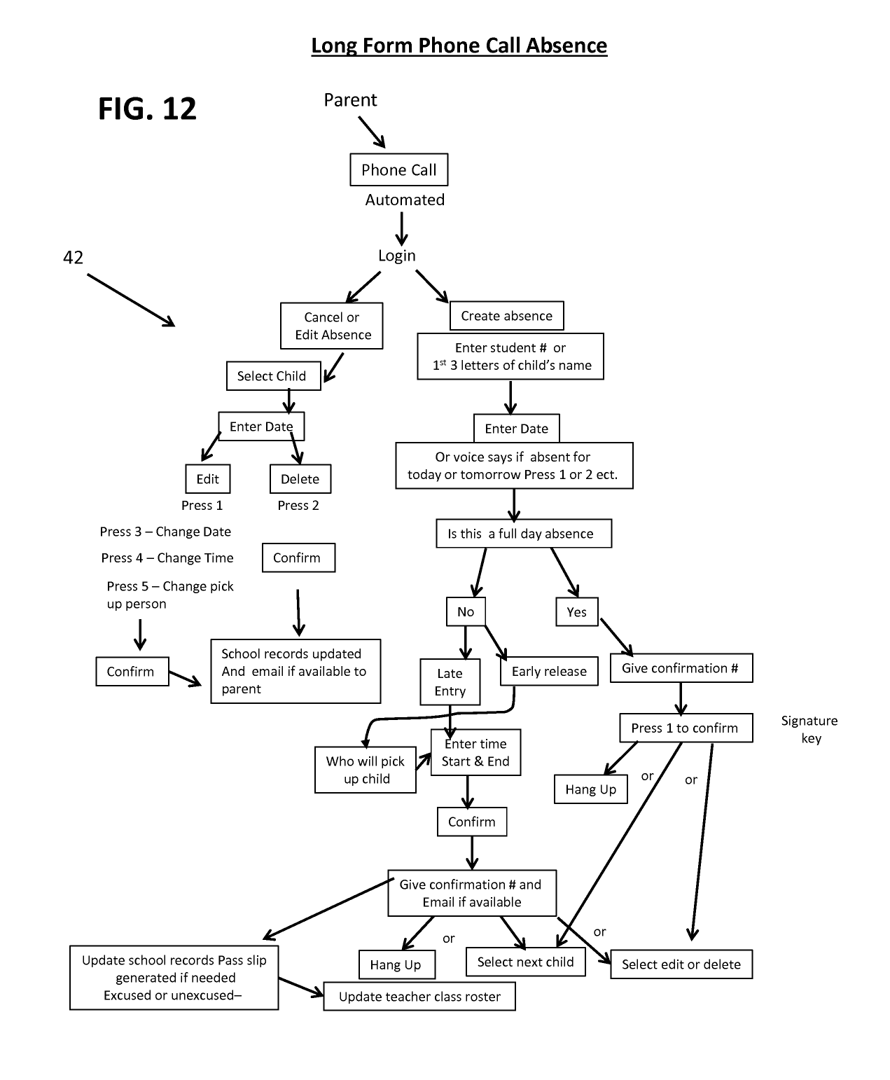

FIG. 12 is a Long Form Phone Call Absence flowchart.

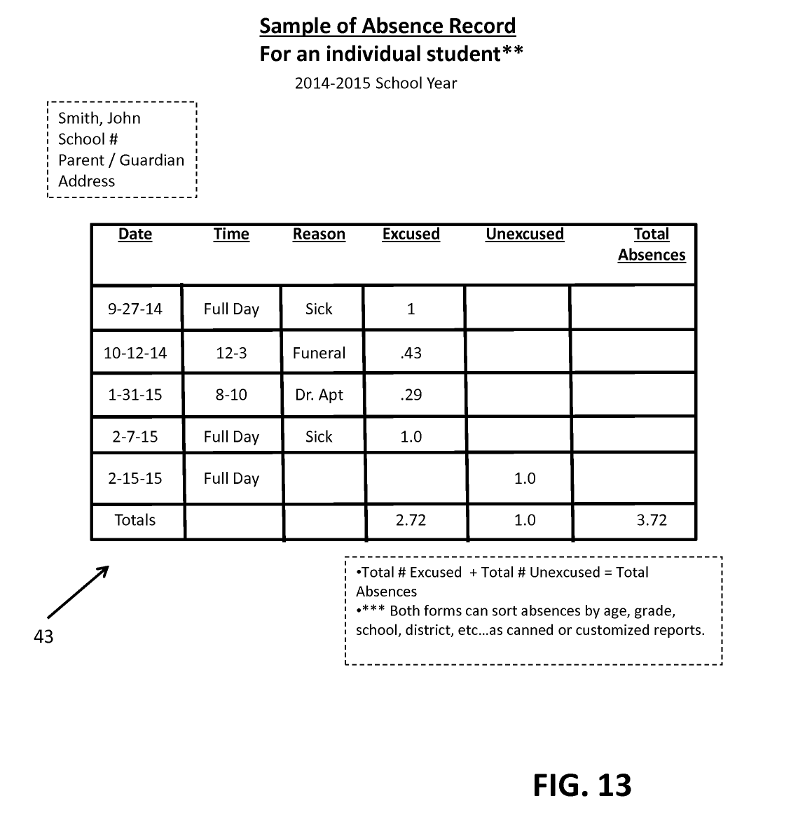

FIG. 13 is a Sample of Absence Record for a Long Form.

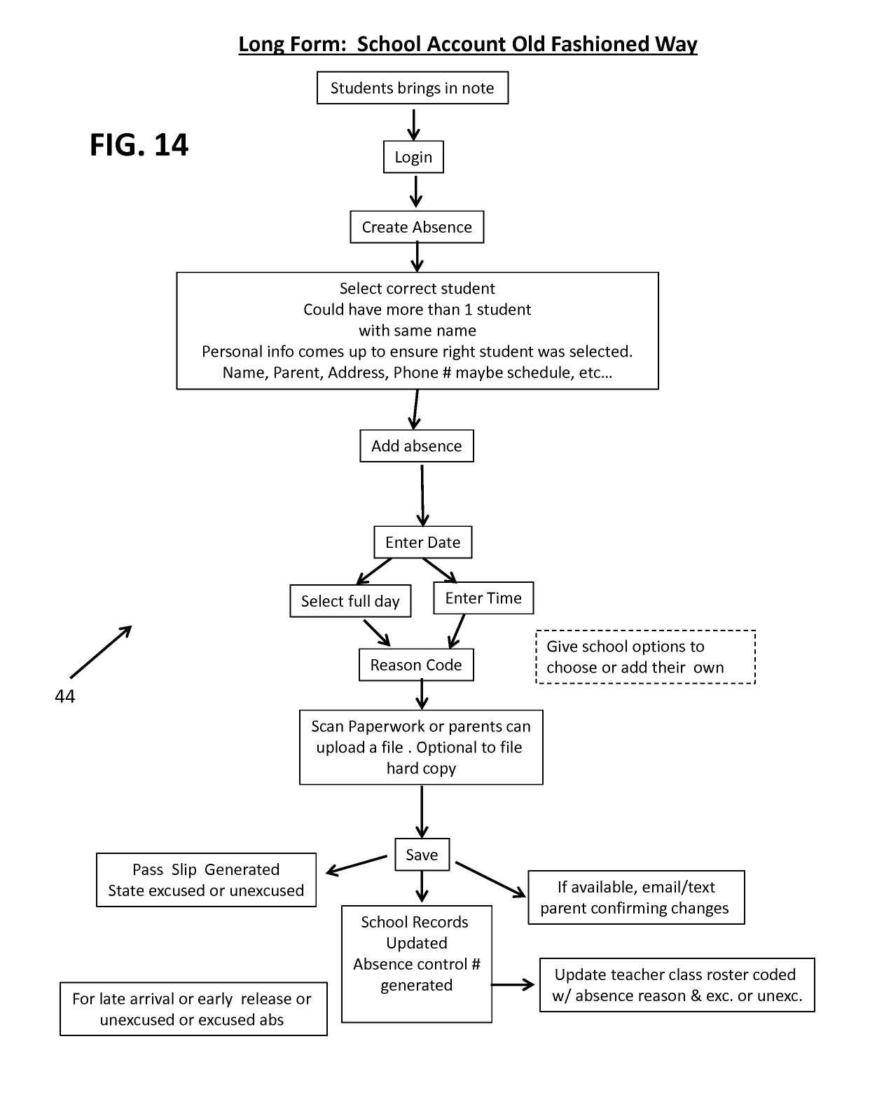

FIG. 14 is a Long Form: School Account done by the Old Fashioned Way.

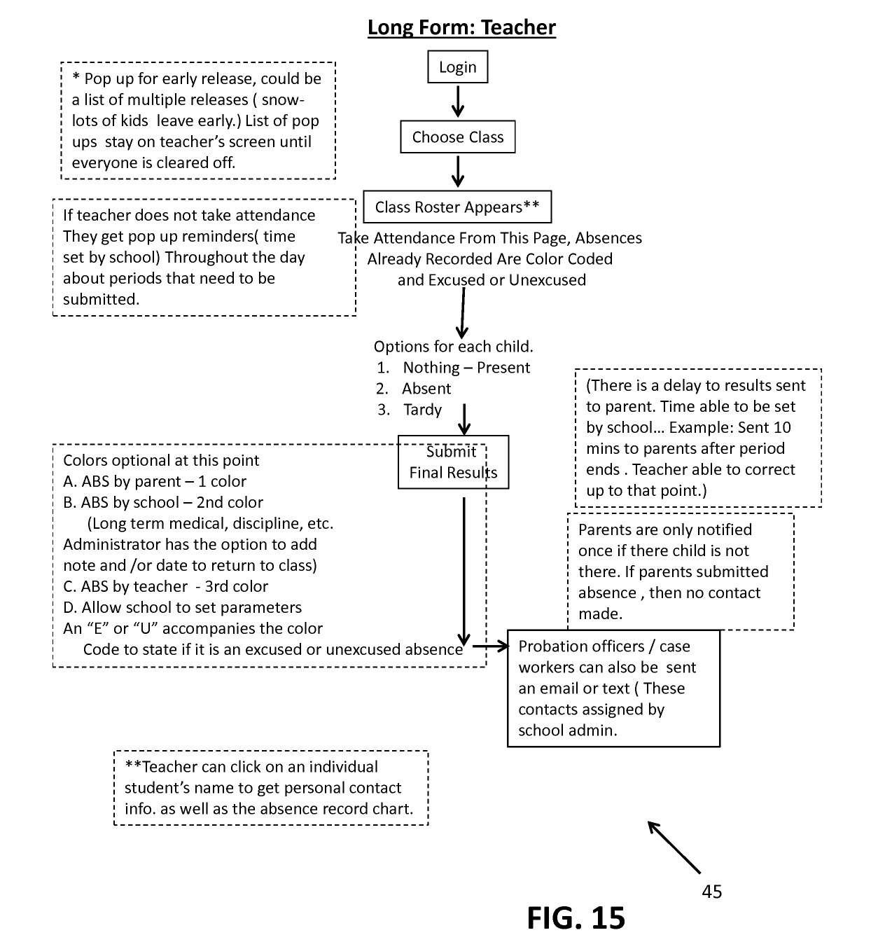

FIG. 15 is a Long Form: Teacher flowchart for a Long Form.

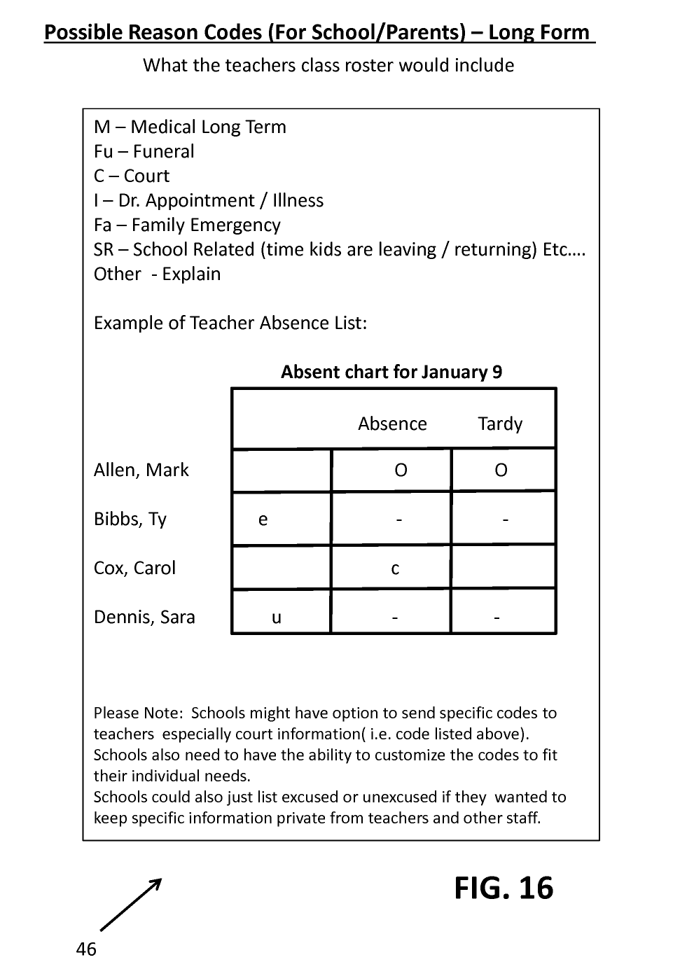

FIG. 16 is a Possible Reason Codes table (For School/Parents)—Long Form.

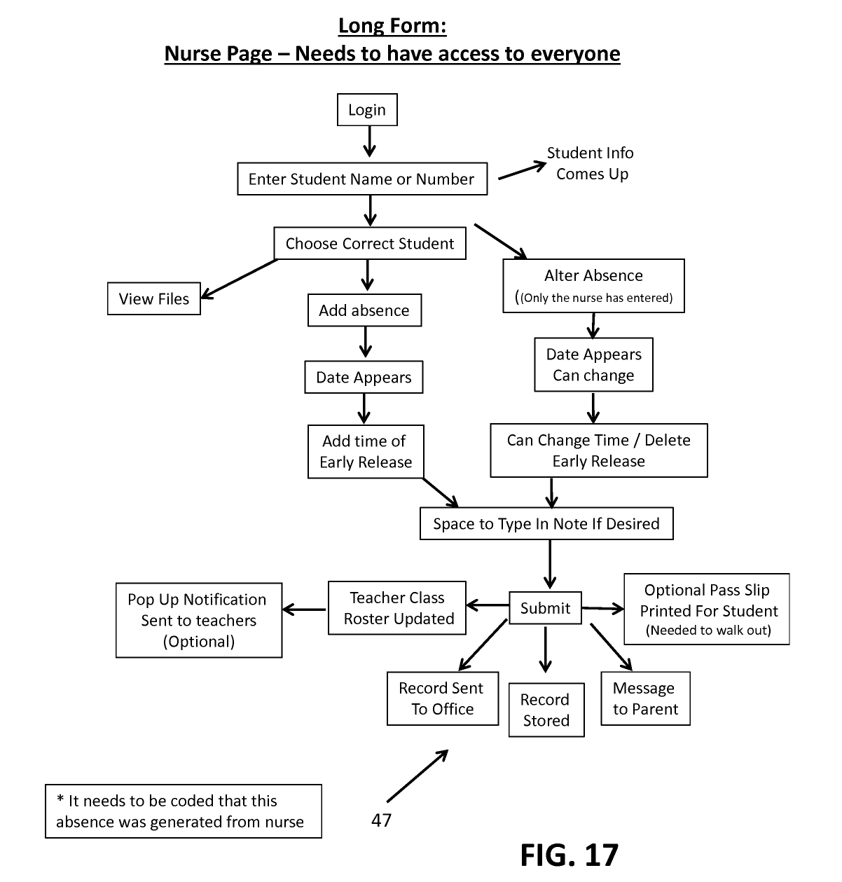

FIG. 17 is a flowchart for a Long Form: Nurse Page—this needs to have access to everyone.

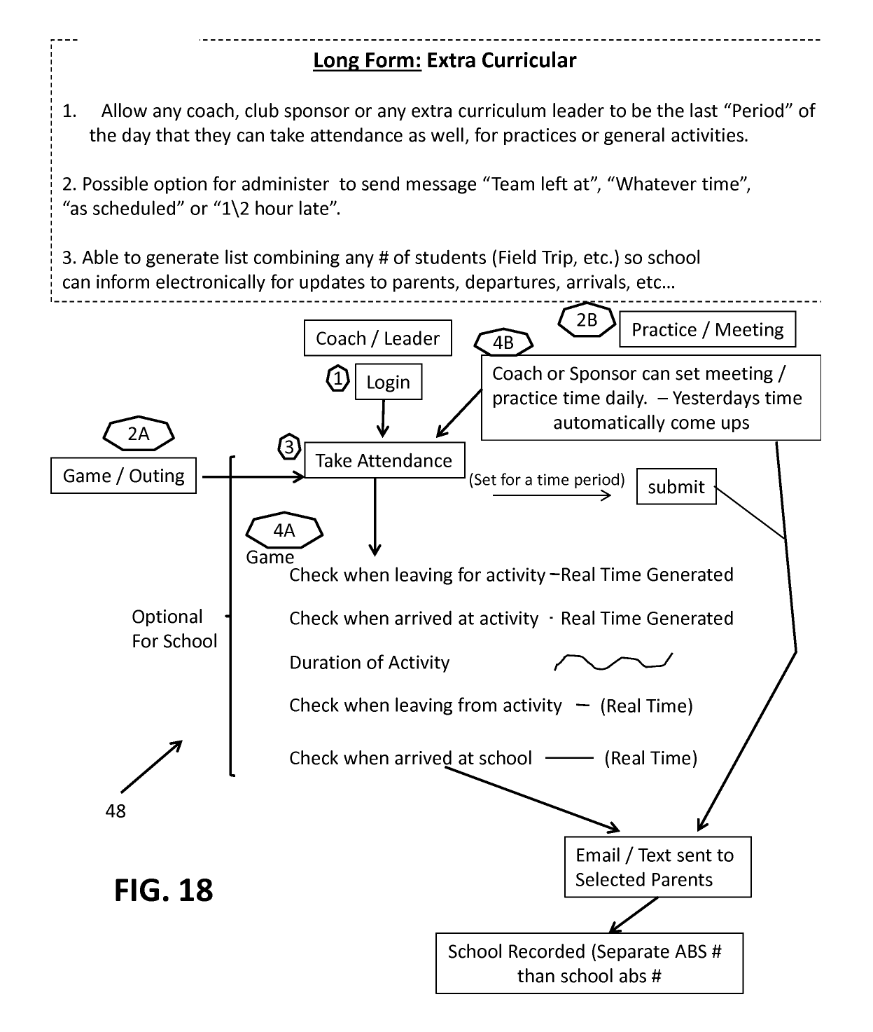

FIG. 18 is a flowchart for a Long Form: Extra Curricular activities.

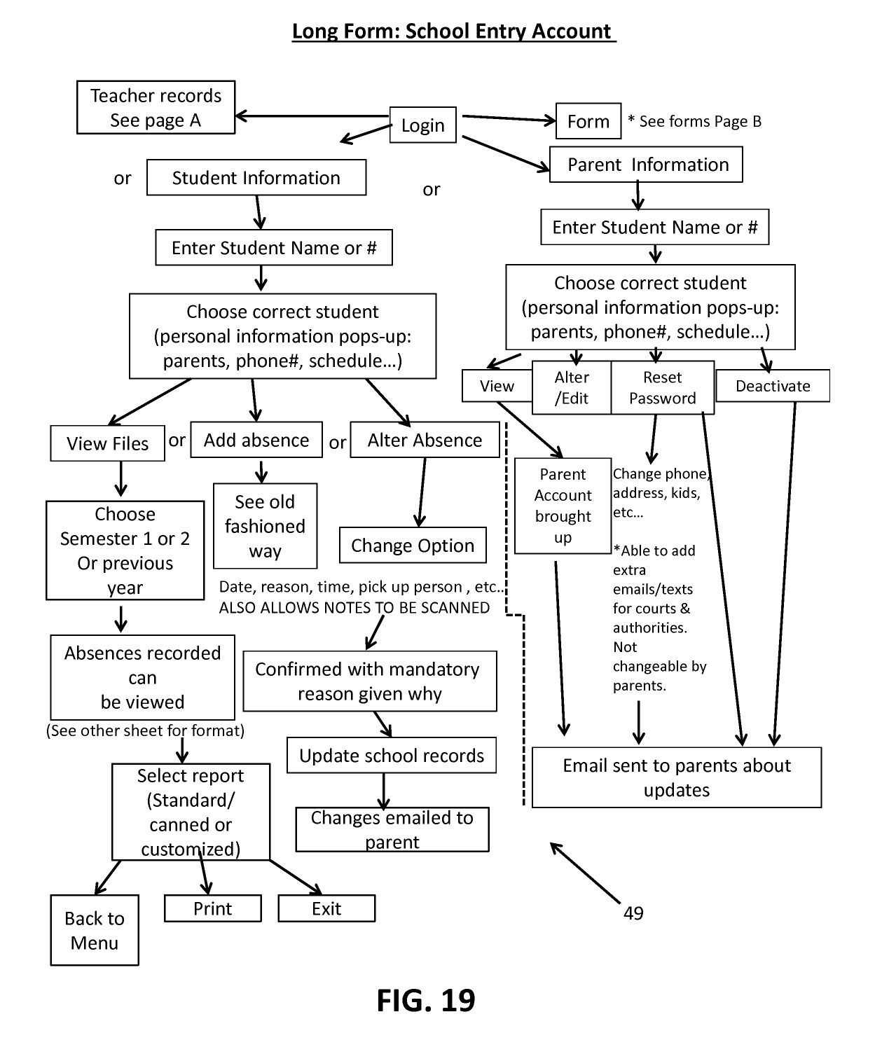

FIG. 19 is an Example of Long Form: School Entry Accounts.

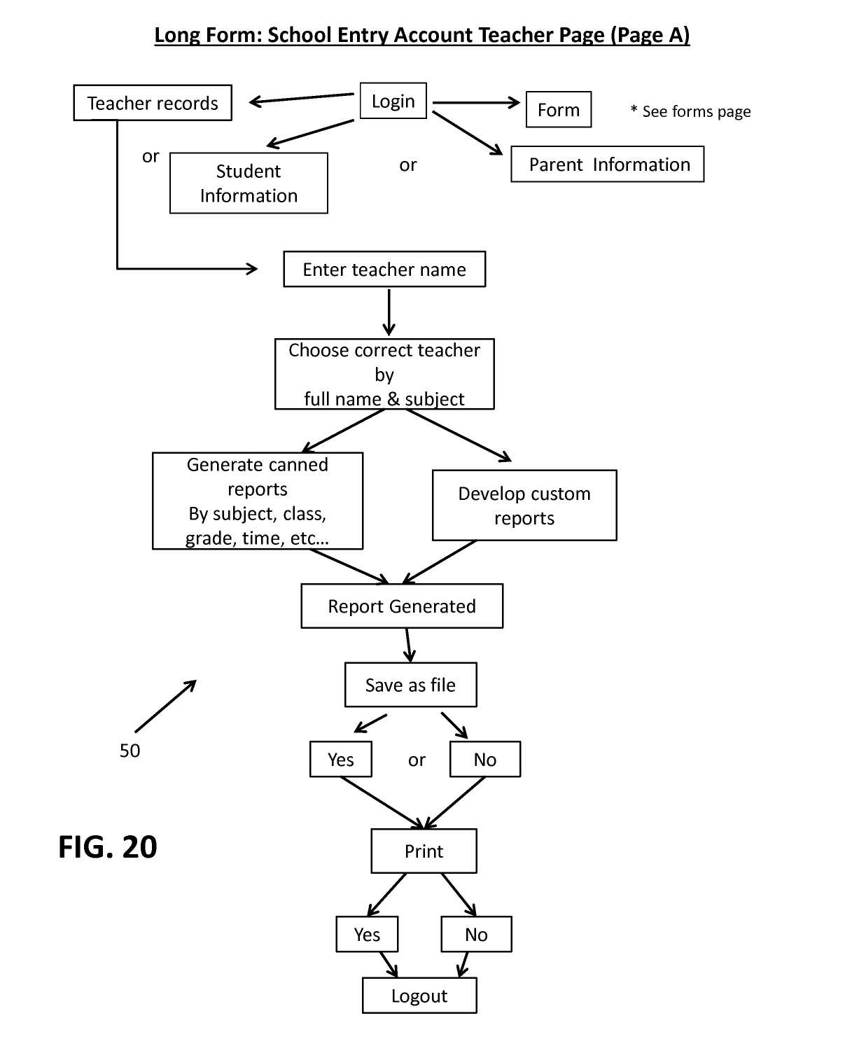

FIG. 20 is a Long Form: School Entry Account Teacher Page (Page A).

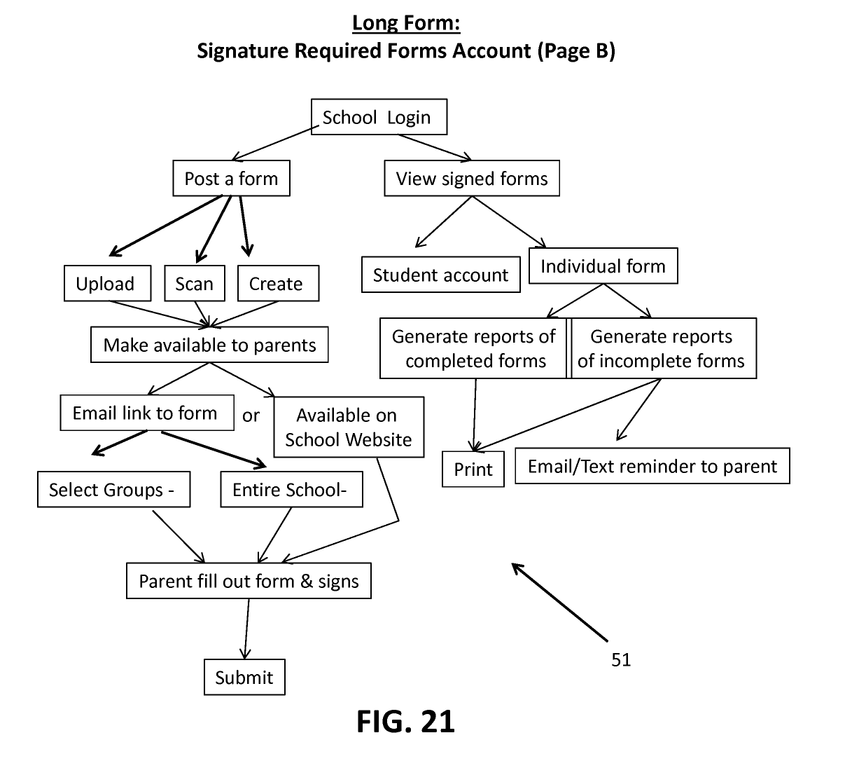

FIG. 21 is an Example of a Long Form: Signature Required Forms Account (Page B).

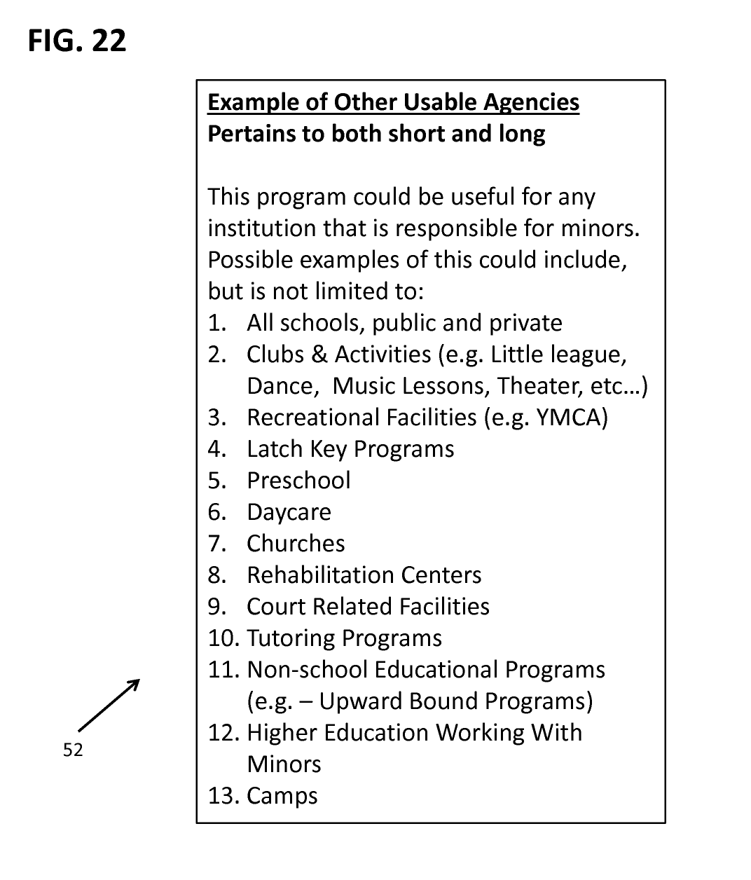

FIG. 22 is a list of Examples of Other Usable Agencies.

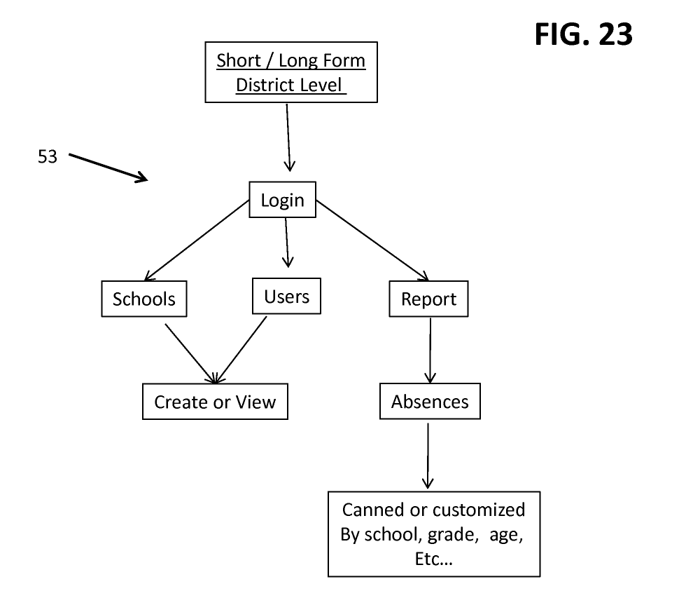

FIG. 23 is a Short/Long Form District Level.

### DESCRIPTION OF THE DRAWINGS

### Reference Numerals

The following list refers to the drawings:

TABLE B
Reference numbers

| Ref # | Description |
|---|---|
| 30 | Interactive and Real-Time Absentee System - short |
| | form 30 |
| 30A | Interactive and Real-Time Absentee System - long |
| | form 30A |
| 31 | Parent Account Setup Form: Short Form Version 31 |
| 31A | Details of Parent Account Setup Form: Short Form |
| | Version 31A |
| 33 | Short Form: Parent Account-Absence Entry 33 |
| 34 | Short Form: Phone Call Absence 34 |
| 35 | Example Reason Codes (For School/Parents) for a |
| | Short Form 35 |
| 36 | Sample of Absence Record for a Short Form 36 |
| 37 | Short Form: School Account by the Old Fashioned Way |
| | 37 |
| 38 | Short Form: School Entry Account 38 |
| 39 | Short Form Signature Required Forms Account 39 |
| 40 | Parent Account Setup Form: Long Form Version 40 |
| 41 | Long Form: Parent Account - Absence Entry 41 |
| 42 | Long Form Phone Call Absence flowchart 42 |
| 43 | Sample of Absence Record for a Long Form 43 |
| 44 | Long Form: School Account done by the Old Fashioned |
| | Way 44 |
| 45 | Long Form: Teacher flowchart for a Long Form 45 |
| 46 | Possible Reason Codes table (For School/Parents) - |
| | Long Form 46 |
| 47 | Long Form: Nurse Page 47 |
| 48 | Long Form: Extra Curricular activities 48 |
| 49 | Example of Long Form: School Entry Accounts 49 |
| 50 | Long Form: School Entry Account Teacher Page (Page |
| | A) 50 |
| 51 | Example of a Long Form: Signature Required Forms |
| | Account (Page B) 51 |
| 52 | list of Examples of Other Usable Agencies 52 |
| 53 | Short/Long Form District Level 53 |

### DETAILED DESCRIPTION OF PREFERRED EMBODIMENT

The present development is an Interactive and Real-Time Absentee System for Schools, Parents and Other Institutions. More particularly, this invention relates to systems and methods for tracking the location of individuals, such as students entering or leaving a school or classroom and for managing critical student information. The present invention also relates to methods of reporting student behavior, and in particular a method of reporting student relevant data including behavior to parents and interested private/government institutions over a computer network. This invention relates to an attendance monitoring system. More particularly, the invention is directed to a system that provides to a school system, parents or interested private/government institutions an instant visual representation of a student's daily attendance (including that for the present day) and attendance history (which is an indicator of potential concerns). The present embodiments further relate to an immediate response information or emergency system for guardians, employees, and students associated with an institution, such as a school or a school system relating to student daily attendance which can relate to tracking attendance of a child in case of an emergency situation or knowing where the child is while in an institution or school system. This invention relates to data logging systems, and in particular, to systems for logging or registering items of data related to persons. It is, although not exclusively, adapted for use as a classroom roll-taking system, for recording the presence or absence of pupils or students, their test results and other such data.

Taught here are the ways an absentee reporting system may be improved to have a fully interactive capability. This may be an adaptive system tied in to existing absentee systems or a fully new and expanded system to anticipate and interactively report the curricular and extracurricular activities—hence permitting the student's real time location and presences at events to be known by educational persons, parents and guardians, and other governmental agencies.

The advantages for the Interactive and Real-Time Absentee System 30 for Schools, Parents and Other Institutions listed above in the introduction. Succinctly the benefits are that the system:
1. Decrease liability for the school
2. Saves paper and students will no longer have to physically bring in the note (documentation—Dr.'s note, funeral, court, etc. . . . ) to the school nor risk losing the documentation
3. Save time for secretaries, teachers, parents, students and administration
   A. Parents won't have to call or write notes
   B. Students won't have to go to office if parents participate and wait in line at the attendance office
   C. Secretaries won't have to wait on as many individual students
   D. Administrators can look at compounded records*hopefully, based on parent participation, attendance records will be more accurate.
4. Better Security
   F. Direct communication Parent <-> School and vice versa.
   G. Electronic signatures and/or pins to meet or exceed HIPPA and FERPA requirements.
   H. More accountability about student's whereabouts and who is picking them up.
   I. More accountability for older students to be where they are supposed to be.
   J. Better timely notification to parents
5. Better documentation: more efficient and accurate
6. The potential to assist non-school community services
7. Children are better protected
8. Parents gain more efficiency, freedom and empowerment over children's absence accountability.
9. Saves learning time—Kids don't have to wait in line to check in an attendance or get pass slips.
10. Parents are happier/staff happier promoting better working conditions.
11. Allows parents to feel more secure.
12. Provides more convenience for the people (all parties) to communicate in a less social setting which according to statistics, will increase the participation. (They parents/guardians can email or upload, etc. without needing to talk to anyone.)

The preferred embodiment of the Interactive and Real-Time Absentee System for Schools, Parents and Other Institutions is comprised of: (a) an existing absentee reporting system or new reporting system; (b) a portal means for communicating and exchanging information like a call-in website by email and/or cellphone application and/or telephone; (c) a log-in process to choose/and-or create a file for a specific child; (d) a review file of recent absentees and/or tardiness; (e) a manner to enter and/or edit a reason code for the absentee or tardiness; (f) a means for securely signing (electronic signature or pin codes or the like) for acknowledging absenteeism and other school forms; and (g) an interactive comments capability (like email comments; text comments through a smartphone application; an email a sound recording; email a video response; attach recorded comments through a smartphone application; and attach videoed comments through a smartphone application) wherein the Interactive and Real-Time Absentee System for Schools, Parents and Other Institutions may be accessed on a real time basis for interaction between school systems (teachers, secretary and administrators) with the parent, guardian and governmental institutions. An alternative embodiment is the system described above and further comprised of after school and curricular activities wherein sponsors or coaches can interact and advise parents/guardians, etc. of the location and presence of the student at such extracurricular activities.

There is shown in FIGS. 1-23 a complete description and operative embodiment of the Interactive and Real-Time Absentee System for Schools, Parents and Other Institutions. In the drawings and illustrations, one notes well that the FIGS. 1-23 demonstrate the general configuration, concept and use of this system/process. The various example uses are in the operation and use section, below.

The accompanying drawings, which are incorporated in and constitute a part of this specification, illustrate an embodiment of the Interactive and Real-Time Absentee System for Schools, Parents and Other Institutions 30, 30A that is preferred. The drawings together with the summary description given above and a detailed description given below serve to explain the principles of the Interactive and Real-Time Absentee System for Schools, Parents and Other Institutions 30, 30A. It is understood, however, that the Interactive and Real-Time Absentee System for Schools, Parents and Other Institutions 30, 30A is not limited to only the precise arrangements and instrumentalities shown. Other examples of the Interactive and Real-Time Absentee System for Schools, Parents and Other Institutions and in the art of interactive communications, it is readily understood that the features shown in the examples with this product are readily adapted to other types of tracking and reporting systems for various institutions—education, government, institutional and the like to be within the scope and spirit shown here.

FIGS. 1 A and 1 B are sketches of the Interactive and Real-Time Absentee System 30, 30A for Schools, Parents and Other Institutions and Simple block diagrams of short and long systems. Shown here are the Interactive and Real-Time Absentee System—short form 30 combining and interfacing into existing systems and Interactive and Real-Time Absentee System—long form 30A for totally new systems. The specific steps and sub-steps are self-explanatory from the detailed drawings and description. The Short Form Option 30 combining and interfacing into existing systems is further described as: The short form will basically allow schools the ability to keep the parents signature on file. They will be able to keep track of all student absences reported by the parents. The big perk with the short form is just the liability taken off the school and onto to parents and students for absences. Also offered is the ability to upload any form they may need to get signatures of parents (i.e. . . . medical release, permission slips, free and reduced lunch, etc. . . . ). Only school administration and select secretaries and parents will have access to this information. The process must include:
A way for parents to set up a school account
A way for parents to submit and review absences (website, app, and phone-in)
A way for parents to cancel an absence that hasn't come to date yet
A way for parents to say who will pick up the student and school can see that information
A way for parents and the school to scan in notes
A way for the school to enter an old fashioned absence “bring in note”
A way for the school to correct parent account and or re-set password
A way for the school to review absence (Absence chart)
A pass slip to be generated for students recorded for early release or late entry
   The Long Form Option 30A for a totally new system is further comprised and described as: If the client chooses the long form option they will receive everything the short program offers plus the ability for the daily school attendance to be recorded as well as extracurricular activities. Teachers, coaches, advisors, nurse and anyone involved in extracurricular activities could be involved in this process. This Long Form Option 30A for a totally new system must include:
All the short program options
The initial parent form (setting up the account) must include a way for parents to mark “want information about specific extracurricular activities. (i.e., boys' basketball, girls track, freshman choir, etc. . . . ) Parents can change whether they want to receive info. at any time
The daily school attendance (during regular hours for each period to be recorded)
The ability for courtesy (calls, text or email) to be sent to parents if their child is marked absent after a specified time
Also school has the ability to mark a child absent for extended time due to illness, family crisis, pregnancy, etc. . . . (pop-up notice or email about long term date approaching for student to return or time extended)
Option for attendance to be taken during extracurricular activities
Option for notices to be sent to parents about extracurricular activities (i.e., practice times, departures, arrivals, cancellations, etc. . . . )
Full attendance records including parents recorded absences and school absences combined or separate
A way for the nurse to mark if a student is sent home early and optional pass slip generated and or email/text sent to current period teacher, attendance secretary and parent.
   Telephone cellular applications includes and is comprised as:
1. Parents can use website/app or Call-In or let kid bring in note.
2. Parents Pick going to a website or using a smartphone application.
3. Parents Login with electronic signature and or pin to absence systems and form signing (various types discussed herein).
4. Parents consider and choose options to change personal account (Account Form) or Pick Child.
5. System has Documentation—Dr's note or court note and parents still need to have an option for kids to bring in documentation instead of scan.
6. Only goes to teacher program if school buys long form. Teachers may get access to short form as well.
7. Also when school records are updated, an option for pass slip to be generated.
8. If parents call in a “late entry and/or early release” need to be an option.
   In all cases, the long or short form system 30, 30A, the interactive comments capability include for example and not limitations email comments; text comments through a smartphone application; an email a sound recording; email a video response; attach recorded comments through a smartphone application; and attach videoed comments through a smartphone application.

FIGS. 2 A and 2 B are sketches of the Parent Account Setup Form: Short Form Version 31 as noted. The specific steps and sub-steps are self-explanatory from the detailed drawings and description. One notes several points: a Group (Foster) Home can have up to 50 names as opposed to a basic family; if one wants to be sent confirmation absence details notices, they may by text messages, electronic mail or both; and if one doesn't choose a notice, the person must answer a disclaimer of notice, etc. Of special importance is the disclaimer that Personal info. will never be shared or sold to third parties.

FIG. 3 is a flowchart of the Short Form: Parent Account—Absence Entry 33. The specific steps and sub-steps are self-explanatory from the detailed drawings and description. One notes the portal means for communicating and exchanging information include telephone calls, website/email, or smartphone applications. Also, one notes if a date is entered into the system that already exists, then one must choose to change or delete. Here, past dates may be viewed but not altered by parents. Shown also are sample certain reason codes like: sick, funeral, court, etc. and codes will mark Excused or Unexcused absence. There is also a setting that permits establishing for the allowable number of school days accepted by school for excused absences, before documentation is needed and these numbers are able to be re-set each semester. This documentation is in a file that is generated (user-friendly and quick) and sent to a school administrator/secretary to determine validity. Finally, the electronic mail or text confirmation to parent relays the child's name, date, time, who picked up, etc.

FIG. 4 is a flowchart of Short Form: Phone Call Absence 34. The specific steps and sub-steps are self-explanatory from the detailed drawings and description.

FIG. 5 is an Example Reason Codes (For School/Parents) for a Short Form 35. The specific steps and sub-steps are self-explanatory from the detailed drawings and description. Reason codes, for example and not as a limitation are: M—Medical Long Term; Fu—Funeral; C—Court; I—Dr. Appointment/Illness; Fa—Family Emergency; SR—School Related (provides time kids are leaving/returning) and O—other reasons—space to explain. The schools have the ability to customize this to their individual needs with different opportunities to customize reports; number of excused/unexcused absences; time set by full day absence (Partial days) and whatever forms school wants signed.

FIG. 6 is a Sample of Absence Record for a Short Form 36. The specific steps and sub-steps are self-explanatory from the detailed drawings and description. Short Form ONLY will include parent/school entered absences. Form can create standard (canned) and customized reports by age, grade, school, district, etc.

FIG. 7 is a Short Form: School Account by the Old Fashioned Way 37. The specific steps and sub-steps are self-explanatory from the detailed drawings and description. One notes the Reason Code provides the schools options to customize their respective codes to meld and blend with the current system if needed. When using this portion of the system, personal information comes up to ensure right student was selected. Information such as name, parent, address, telephone number, schedule, etc.

FIG. 8 is a Short Form: School Entry Account 38. The specific steps and sub-steps are self-explanatory from the detailed drawings and description.

FIG. 9 is a Short Form Signature Required Forms Account 39. The specific steps and sub-steps are self-explanatory from the detailed drawings and description. Main features for any parent signature required form of both long and short forms include: school sets how many emails sent then old fashioned way of collecting paperwork kicks in/begins; a list is generated on non-compliers and 2^{nd} email sent—here the secretary/administrator needs to be printed a list; and a 3^{rd} email is sent if needed and the list reprinted.

FIG. 10 is a Parent Account Setup Form: Long Form Version 40. The specific steps and sub-steps are self-explanatory from the detailed drawings and description.

FIG. 11 is a Long Form: Parent Account—Absence Entry 41. The specific steps and sub-steps are self-explanatory from the detailed drawings and description. One notes several points: several entry/portal means for communicating and exchanging information choices—telephone call, electronic mail, website or smartphone applications; date and time not to be altered after Date/Time passed by parent (needs school authorization); if a date is entered that already exists, then one must choose—change or delete (past dates viewed, not altered). Other portions similar to short form which addresses and connects to the existing absence systems.

FIG. 12 is a Long Form Phone Call Absence flowchart 42. The specific steps and sub-steps are self-explanatory from the detailed drawings and description.

FIG. 13 is a Sample of Absence Record for a Long Form 43. The specific steps and sub-steps are self-explanatory from the detailed drawings and description. One notes: Long form absence record can include teachers, nurse & coaches as well as parents & school already added. Long Form as well as Short Form can create standard (canned) and customized reports by age, grade, school, district, etc.

FIG. 14 is a Long Form: School Account done by the Old Fashioned Way 44. The specific steps and sub-steps are self-explanatory from the detailed drawings and description. Many give the school the option to customize sections for their own desire and use.

FIG. 15 is a Long Form: Teacher flowchart for a Long Form 45. The specific steps and sub-steps are self-explanatory from the detailed drawings and description. One notes in these drawings: Pop up for early release, could be a list of multiple releases (e.g. snow—lots of kids leave early); a list of pop ups stay on teacher's screen until everyone is cleared off; if teacher does not take attendance they get a pop up reminders (time to remind set by school) throughout the day about periods that need to be submitted; take attendance from this page; and absences are already recorded and color coded plus marked excused or un-excused [Colors optional at this point: A. ABS by parent—1 color; B. ABS by school—2^{nd} color; Long term medical, discipline, etc.; administrator has the option to add note and/or date to return to class); C. ABS by teacher—3^{rd} color; D. Allow school to set parameters] and an “E” or “U” accompanies the color to state if it is an excused (“E”) or unexcused (“U”) absence. Further features show there is a delay to results sent to parent at a time able to be set by school. For example: Send notice 10 minutes to parents after period ends. Teacher would be able to correct up to that point. Parents are only notified once if there child is not there. If parents submitted absence, then no contact is made. Further, probation officers/case workers can also be sent an email or text (These contacts assigned by school administration). Here a teacher can click on an individual student's name to get personal contact information as well as the absence record chart.

FIG. 16 is a Possible Reason Codes table (For School/Parents)—Long Form 46. The specific steps and sub-steps are self-explanatory from the detailed drawings and description. Reason codes, for example and not as a limitation are: M—Medical Long Term; Fu—Funeral; C—Court; I—Dr. Appointment/Illness; Fa—Family Emergency; SR—School Related (provides time kids are leaving/returning) and O—other reasons—space to explain. The schools have the ability to customize this to their individual needs with different opportunities to customize reports; number of excused/unexcused absences; time set by full day absence (Partial days) and whatever forms school wants signed.

FIG. 17 is a flowchart for a Long Form: Nurse Page—this page needs to have access to everyone 47. The specific steps and sub-steps are self-explanatory from the detailed drawings and description.

FIG. 18 is a flowchart for a Long Form: Extra Curricular activities 48. The specific steps and sub-steps are self-explanatory from the detailed drawings and description. (1) This allows any coach, club sponsor or any extra curriculum leader to be the last “Period” of the day that they can take attendance as well, for practices or general activities. (2) This provides a possible option for administer to send message “Team left at”, “Whatever time”, “as scheduled” or “1\2 hour late”. (3) This makes it able to generate list combining any # of students (Field Trip, etc.) so school can inform electronically for updates to parents, departures, arrivals, etc. This further permits: Check in real time when leaving for an activity; Check in real time when arrived for an activity; Check in real time the duration of the activity; Check in real time when leaving from an activity; and Check in real time when arriving back at the school. This is a tremendous help to parents/guardians as well as increasing safety and security for the student.

FIG. 19 is an Example of Long Form: School Entry Accounts 49. The specific steps and sub-steps are self-explanatory from the detailed drawings and description.

FIG. 20 is a Long Form: School Entry Account Teacher Page (Page A) 50. The specific steps and sub-steps are self-explanatory from the detailed drawings and description.

FIG. 21 is an Example of a Long Form: Signature Required Forms Account (Page B) 51. The specific steps and sub-steps are self-explanatory from the detailed drawings and description.

FIG. 22 is a list of Examples of Other Usable Agencies and FIG. 23 is a Short/Long Form District Level 53. The FIG. 22 is described and discussed below in the operations section. For FIG. 23 the specific steps and sub-steps are self-explanatory from the detailed drawings and description.

The details mentioned here are exemplary and not limiting. Other specific components and manners specific to describing an Interactive and Real-Time Absentee System for Schools, Parents and Other Institutions 30, 30A may be added as a person having ordinary skill in the art of absentee tracking and reporting and in the art of interactive communications readily understands and well appreciates.

### Operation of the Preferred Embodiment

The Interactive and Real-Time Absentee System for Schools, Parents and Other Institutions 30, 30A has been described in the above embodiment. The manner of how the device operates is further described below. One notes well that the description above and the operation described here must be taken together to fully illustrate the concept of the Interactive and Real-Time Absentee System for Schools, Parents and Other Institutions 30, 30A. The preferred embodiment of the Interactive and Real-Time Absentee System for Schools, Parents and Other Institutions 30, 30A is comprised of: (a) an existing absentee reporting system or new reporting system; (b) a portal means for communicating and exchanging information such as a call-in website by email and/or cellphone application and/or telephone; (c) a log-in process to choose/and-or create a file for a specific child; (d) a review file of recent absentees and/or tardiness; (e) a manner to enter and/or edit a reason code for the absentee or tardiness; (f) a means for securely signing (electronic signature or pin codes or the like) for acknowledging absenteeism and other school forms; and (g) an interactive comments capability wherein the Interactive and Real-Time Absentee System for Schools, Parents and Other Institutions may be accessed on a real time basis for interaction between school systems (teachers, secretary and administrators) with the parent, guardian and governmental institutions. An alternative embodiment is the system described above and further comprised of after school, curricular and extracurricular activities wherein sponsors or coaches can interact and advise parents/guardians, etc. of the location and presence of the student at such curricular and extracurricular activities.

Several potential using agencies as current and future users are anticipated and indicated in FIG. 22 for the Interactive and Real-Time Absentee System for Schools, Parents and Other Institutions 30, 30A. These examples, and not limitations, are as follows. This program could be useful for any private/government institution that is responsible for minors. Possible examples of this could include, but is not limited to:
1. All schools, public and private
2. Clubs & Activities (e.g. Little league, Dance, Music Lessons, Theater, etc. . . . )
3. Recreational Facilities (e.g. YMCA)
4. Latch Key Programs
5. Preschool
6. Daycare
7. Churches
8. Rehabilitation Centers
9. Court Related Facilities
10. Tutoring Programs
11. Non-school Educational Programs (e.g.—Upward Bound Programs)
12. Higher Education Working With Minors
13. Camps.

Many current and future enhancements and uses are anticipated for the Interactive and Real-Time Absentee System for Schools, Parents and Other Institutions 30, 30A. Some examples, and not limitations, are:

A. Technology Advancements:
1. Always progressing with cutting edge advancements in human recognition technology, including, but not limited to fingerprint identification, voice recognition, face identification/recognition, microchip implants (micro-chipping), and eye identification.

B. Administration-Staff-Employees:
1. An announcement system updating all affected employees of important changes including office and building information, as well as district, state, and federal mandates.
2. Able to report and record all teacher/employee evaluations for individual district/company requirements as well as state requirements: Gradebook; discipline; evaluation; foreign language activities; scholarships; interactive communication with government agencies (therapy, courts, probation, Child services, etc.); parents and guardians; and emergency alerts.
3. Create “locker space” for employees and students to store online data.
4. Able to assign students virtual assignments for snow days, college readiness, or absences, etc.
5. Teachers can offer forms to be signed on their school web pages.

C. Students
1. Discipline reports and records are able to be electronically generated and submitted from teachers to administration, with school option to also notify parents.
2. Automatic notification to administration when students are marked “tardy” a certain number of times. Schools can adjust this feature to be a school-wide policy or can accumulate for individual classes.
3. Offer the program in foreign languages.
4. Able to create and manage individual student schedules, teacher schedules, and the master schedule.
5. Students can electronically sign for given responsibilities (i.e.—library books, classroom documents, athletic events, etc.)
6. Students can have access to or check out online textbooks.

D. Parents
1. Parents can be contacted for emergency messaging, individually, school, or district wide.
2. Schools can be given the option to allow parents/guardians to electronically sign for viewing and being informed of grade interims and report cards.
3. Parents are able to electronically receive official signed documents from the school (transcripts, diplomas, grade reports, proof of attendance, possibly with an “electronic watermark, etc.) and electronically sign official documents.
4. Parents can enroll and/or withdraw students by electronically signing required forms.

E. Community
1. For scholarship/award purposes, this program is able to generate reports to colleges, employers, or any community agency about community service, attendance of extra-curricular activities, field trips, or any other school related information.
2. Communicate openly between school and courts, probation officers, social services, therapists, or any business dealing with the students regarding attendance, grades, behavior or any other expected school attitude.
3. Able to send any generated report to government agencies, consultants, presenters, etc., about school related topics and statistics for the betterment of the system.

With this description it is to be understood that the Interactive and Real-Time Absentee System for Schools, Parents and Other Institutions 30, 30A is not to be limited to only the disclosed embodiment of system/process. The features of the Interactive and Real-Time Absentee System for Schools, Parents and Other Institutions 30, 30A are intended to cover various modifications and equivalent arrangements included within the spirit and scope of the description.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

Any of the publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With this description it is to be understood that the Interactive and Real-Time Absentee System for Schools, Parents and Other Institutions 30, 30A is not to be limited to only the disclosed embodiment of product. The features of the Interactive and Real-Time Absentee System for Schools, Parents and Other Institutions 30, 30A are intended to cover various modifications and equivalent arrangements included within the spirit and scope of the description.

What is claimed is:

1. An Interactive and Real-Time Absentee System for Schools, Parents and Other Institutions comprised of:
(a) an existing absentee reporting system;
(b) a portal means for communicating and exchanging information;
(c) a log-in process to choose/and-or create a file for a specific child;
(d) a review file of recent absentees and tardiness with a reason code;
(e) a manner to enter and/or edit a reason code for the absentee or tardiness;
(f) a means for securely signing for acknowledging absenteeism and other school forms; and
(g) an interactive comments capability
wherein the Interactive and Real-Time Absentee System for Schools, Parents and a set of Other Institutions may be accessed on a real time basis for interaction between school systems (teachers, secretary and administrators) with the parent, guardian and private/government institutions.

2. The system described in claim 1 further comprised of monitoring after school and extracurricular activities wherein sponsors or coaches can interact and advise parents/guardians, or officials of the location and presence of the student at such extracurricular activities.

3. The system described in claim 1 wherein the portal means for communicating is a website.

4. The system described in claim 1 wherein the portal means for communicating is a telephone.

5. The system described in claim 1 wherein the portal means for communicating is a smartphone application.

6. The system described in claim 1 wherein the portal means for communicating is an electronic mail system.

7. The system described in claim 1 wherein the reason code is selected from the group consisting of M—Medical Long Term; Fu—Funeral; C—Court; I—Dr. Appointment/Illness; Fa—Family Emergency; SR—School Related and O—other reasons.

8. The system described in claim 1 wherein the means for securely signing is an electronic signature.

9. The system described in claim 1 wherein the set of Other Institutions is selected from the group consisting of all schools, public and private; Clubs & Activities (e.g. Little league, Dance, Music Lessons, Theater, etc.; Recreational Facilities (e.g. YMCA); Latch Key Programs; Preschool; Daycare; Churches; Rehabilitation Centers; Court Related Facilities; Tutoring Programs; Non-school Educational Programs (e.g.—Upward Bound Programs); Higher Education Working With Minors; and Camps.

10. The system described in claim 1 wherein the interactive comments capability is selected from the group consisting of email comments; text comments through a smartphone application; an email a sound recording; email a video response; attach recorded comments through a smartphone application; and attach videoed comments through a smartphone application.

11. An Interactive and Real-Time Absentee System for Schools, Parents and Other Institutions comprised of:
(a) a newly developed absentee reporting system;
(b) a portal means for communicating and exchanging information;
(c) a log-in process to choose/and-or create a file for a specific child;
(d) a review file of recent absentees and tardiness with a reason code;
(e) a manner to enter and/or edit a reason code for the absentee or tardiness;
(f) a means for securely signing for acknowledging absenteeism and other school forms; and
(g) an interactive comments capability
wherein the Interactive and Real-Time Absentee System for Schools, Parents and a set of Other Institutions may be accessed on a real time basis for interaction between school systems (teachers, secretary and administrators) with the parent, guardian and private/government institutions.

12. The system described in claim 11 further comprised of monitoring after school and extracurricular activities wherein sponsors or coaches can interact and advise parents/guardians, or officials of the location and presence of the student at such extracurricular activities.

13. The system described in claim 11 wherein the portal means for communicating is a website.

14. The system described in claim 11 wherein the portal means for communicating is a telephone.

15. The system described in claim 11 wherein the portal means for communicating is a smartphone application.

16. The system described in claim 11 wherein the portal means for communicating is an electronic mail system.

17. The system described in claim 11 wherein the reason code is selected from the group consisting of M—Medical Long Term; Fu—Funeral; C—Court; I—Dr. Appointment/Illness; Fa—Family Emergency; SR—School Related and O—other reasons.

18. The system described in claim 11 wherein the means for securely signing is an electronic signature.

19. The system described in claim 11 wherein the set of Other Institutions is selected from the group consisting of all schools, public and private; Clubs & Activities (e.g. Little league, Dance, Music Lessons, Theater, etc.; Recreational Facilities (e.g. YMCA); Latch Key Programs; Preschool; Daycare; Churches; Rehabilitation Centers; Court Related Facilities; Tutoring Programs; Non-school Educational Programs (e.g.—Upward Bound Programs); Higher Education Working With Minors; and Camps.

20. The system described in claim 11 wherein the interactive comments capability is selected from the group consisting of email comments; text comments through a smartphone application; an email a sound recording; email a video response; attach recorded comments through a smartphone application; and attach videoed comments through a smartphone application.
